(19) United States
(12) Patent Application Publication
(10) Pub. No.: US 2026/0267751 A1
(43) Pub. Date: Sep. 10, 2026

(54) MANAGING SIDEBAND FAILURES BETWEEN CHIPLETS

(71) Applicant: QUALCOMM Incorporated, San Diego, CA (US)

(72) Inventors: Ravindranath DODDI, Hyderabad (IN); Ramacharan SUNDARARAMAN, San Jose, CA (US)

(21) Appl. No.: 19/074,572

(22) Filed: Mar. 10, 2025

(51) Int. Cl. G06F 11/20

(52) U.S. Cl. CPC G06F 11/2005

(57) ABSTRACT

A chiplet includes a primary sideband port, an auxiliary sideband port, and a control circuit. The primary sideband port communicates control data to a peer chiplet via sideband lanes. Further, the auxiliary sideband port communicates management data to the peer chiplet via auxiliary sideband lanes. When the communication of the control data via the sideband lanes fail, the control circuit reconfigures the auxiliary sideband port. Upon reconfiguring the auxiliary sideband port, the control circuit further controls the communication of the control data and the management data via the auxiliary sideband lanes to the peer chiplet.

### BACKGROUND

### Field of the Disclosure

The present disclosure relates generally to electronic systems, and, more particularly, to communication between chiplets in an electronic system.

### Description of Related Art

With the rapid scaling of electronic systems, multiple dies that perform specific functions are integrated into a single package. The dies may be a processing die, a memory die, an input/output interfacing die, or the like, and are generally manufactured by various vendors. A Universal Chiplet Interconnect Express (UCIe) standardized framework is employed to define signaling protocols between such dies via dedicated communication lanes. Each die conforming to UCIe may thus be referred to as a UCIe chiplet. Further, the communication lanes may be separated into mainband lanes and sideband lanes.

A UCIe chiplet typically includes multiple modules, with each module equipped with a mainband port and a sideband port. The mainband port may facilitate exchange of operational data between chiplets via the mainband lanes, while the sideband port handles communication of control data between the chiplets via the sideband lanes. In an event that the sideband lanes experience faults, the UCIe chiplets fail to exchange the control data with each other. The failure to exchange the control data further disrupts the coordination required for communicating the operational data, effectively rendering the chiplets unusable. Consequently, a semiconductor package including such faulty sideband lanes may suffer from reduced yields due to the unusable chiplets and the associated loss of inter-chiplet communication.

### SUMMARY

Aspects of the disclosure provide a primary chiplet. The primary chiplet may comprise a primary sideband port, an auxiliary sideband port, and a control circuit. The primary sideband port may be configured to communicate first data to a peer chiplet via one or more first sideband lanes. The auxiliary sideband port may be configured to communicate second data to the peer chiplet via one or more second sideband lanes. Further, the control circuit may be configured to detect a failure in the communication of the first data via the one or more first sideband lanes. The control circuit may be further configured to reconfigure the auxiliary sideband port based on the detected failure. The control circuit is further configured to control, based on the reconfigured auxiliary sideband port, communication of the first data and the second data via the one or more second sideband lanes to the peer chiplet.

In certain aspects of the disclosure, a peer chiplet is disclosed. The peer chiplet may comprise a peer sideband port and a peer auxiliary sideband port. The peer sideband port may be configured to receive first data from a primary chiplet via one or more first sideband lanes. Further, the peer auxiliary sideband port may be configured to receive second data from the primary chiplet via one or more second sideband lanes. The peer auxiliary sideband port may be further configured to receive, based on a failure to receive the first data via the one or more first sideband lanes, the first data in addition to the second data via the one or more second sideband lanes from the primary chiplet.

In certain aspects of the disclosure, a method executed at a primary chiplet is disclosed. The method may comprise detecting a failure in a communication of first data to a peer chiplet via one or more first sideband lanes coupled to a primary sideband port of the primary chiplet. The method may further comprise reconfiguring an auxiliary sideband port of the primary chiplet based on the detected failure, and controlling, based on the reconfiguring of the auxiliary sideband port, communication of the first data and second data, to the peer chiplet via one or more second sideband lanes coupled to the auxiliary sideband port.

To the accomplishment of the foregoing and related ends, the one or more implementations include the features hereinafter fully described and particularly pointed out in the claims. The following description and the annexed drawings set forth in detail certain illustrative aspects of the one or more implementations. These aspects are indicative, however, of a few of the various ways in which the principles of various implementations may be employed and the described implementations are intended to include all such aspects and their equivalents.

### BRIEF DESCRIPTION OF THE DRAWINGS

Various aspects of the present disclosure are illustrated by way of example, and not limited by the appended figures, in which like references indicate similar elements:

FIG. 1 is a schematic block diagram of an electronic system, in accordance with certain aspects of the present disclosure;

FIG. 2 illustrates a block diagram of a primary chiplet and a peer chiplet of the electronic system of FIG. 1, in accordance with certain aspects of the present disclosure;

FIG. 3A illustrates a control register of a chiplet of the electronic system of FIG. 1, in accordance with certain aspects of the present disclosure;

FIG. 3B illustrates a select register of a chiplet of the electronic system of FIG. 1, in accordance with certain aspects of the present disclosure;

FIG. 4 is a state machine that illustrates various states to activate an interconnect for communication of the first data and the second data from a primary chiplet to a peer chiplet of the electronic system of FIG. 1 in accordance with certain aspects of the present disclosure.

FIGS. 5A and 5B are a flowchart that illustrate a method (e.g., a process) executed by a control circuit of the primary chiplet of FIG. 2 in accordance with certain aspects of the present disclosure;

FIG. 6 is a flowchart that illustrates a method (e.g., a process) executed by an auxiliary sideband port of the primary chiplet of FIG. 2 in accordance with certain aspects of the present disclosure;

FIG. 7 is a high-level flowchart that illustrates a method (e.g., a process) executed by a control circuit of the primary chiplet of FIG. 2 in accordance with certain aspects of the present disclosure;

FIG. 8 is a flowchart that illustrates a method (e.g., a process) executed by a peer auxiliary sideband port of the peer chiplet of FIG. 2 in accordance with certain aspects of the present disclosure; and

FIG. 9 is a block diagram of a chiplet of the electronic system of FIG. 1 in accordance with certain aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form to avoid obscuring such concepts.

Several aspects of the disclosure will now be presented with reference to an apparatus and method. Such apparatus and method will be described in the following detailed description and illustrated in the accompanying drawings by various blocks, modules, components, circuits, steps, processes, or the like (collectively referred to as “elements”).

Accordingly, in one or more aspects, the functions described by elements of the disclosure may be implemented in hardware, software, or any combination thereof depending upon the particular application and design constraints imposed on the overall apparatus. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

At least one of a host processor, a control circuit, a processing circuit, or any portion of any of such components, or any combination of such components may be implemented as a “processing system” that may include one or more processors. Examples of processors include microprocessors, microcontrollers, graphics processing units, central processing units, application processors, digital signal processors, reduced instruction set computing processors, systems on a chip, baseband processors, field programmable gate arrays, programmable logic devices, state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

In today's technology landscape, chiplets manufactured by various vendors are integrated within a single electronic system or device. Such chiplets are coupled by way of a Universal Chiplet Interconnect Express (UCIe) interconnect to facilitate seamless communication between the chiplets. Each chiplet typically includes multiple modules, with each module including a mainband port and a sideband port. The mainband port of one chiplet is coupled to the mainband port of another chiplet via one or more mainband lanes, while the sideband port is coupled to the corresponding sideband port of the other chiplet via one or more sideband lanes. The mainband port communicates operational data associated with execution of applications on the interconnected chiplets, via the one or more mainband lanes. Further, the sideband port communicates control data via the one or more sideband lanes to control the exchange of operational data between the chiplets. If an operational or mechanical fault occurs in the one or more sideband lanes, in any of the connected sideband ports, or due to similar issues, the communication of the control data via the one or more sideband lanes may fail. The failure to communicate the control data via the one or more sideband lanes may result in a complete loss of communication between the chiplets, thereby rendering the chiplets unusable. Further, a yield of a semiconductor package that includes such faulty sideband lanes and unusable chiplets may be affected.

Certain aspects disclosed herein provide methods, circuits and systems that are adapted to manage sideband failure between chiplets. For example, a primary chiplet and a peer chiplet may be coupled via mainband lanes, sideband lanes, and auxiliary sideband lanes. Each of the primary chiplet and the peer chiplet includes a main module that supports mainband communication (e.g., communication of mainband data) and sideband communication (e.g., communication of sideband data), and an auxiliary module that exclusively supports sideband communication. The auxiliary module of each of the primary chiplet and the peer chiplet includes an auxiliary sideband port. Further, the auxiliary sideband ports of the primary chiplet and the peer chiplet are coupled via auxiliary sideband lanes to communicate management data associated with at least testing and debug operations between the primary chiplet and the peer chiplet.

When a failure is encountered to communicate the control data over the sideband lanes between the primary chiplet and the peer chiplet, a control circuit of the primary chiplet may repurpose, e.g., reconfigure, the auxiliary sideband port to communicate the control data in addition to the management data between the primary chiplet and the peer chiplet via the auxiliary sideband lanes.

Prior to repurposing or reconfiguring the auxiliary sideband port, the control circuit may determine the capability of the auxiliary sideband port to communicate the control data, and further determine by way of one or more register bits, whether the auxiliary sideband port can multiplex the control data and the management data. Upon determining such capabilities of the auxiliary sideband port, the capabilities may be advertised to the auxiliary sideband port of the peer chiplet. In addition, the control circuit may further receive an acknowledgement from the peer chiplet regarding the capability of the auxiliary sideband port to support the communication of the control data and the management data. The auxiliary sideband port and the auxiliary sideband lanes are thus repurposed to communicate the control data in addition to the management data.

Thus, by controlling the communication of both the control data and the management data via the repurposed auxiliary sideband port, the primary chiplet and the peer chiplet are able to communicate the control data with each other in an event of a failure of the sideband lanes. Thus, a yield of an electronic system that includes such chiplets is improved as compared to conventional techniques that render a chiplet unusable in an event of a sideband lane failure. Further, a reliability of such an electronic system is enhanced. An efficiency of such an electronic system is further enhanced as an idle time of the auxiliary sideband port is utilized to communicate the control data. In addition, the present disclosure provides a simple solution to detect the aforementioned capabilities of the auxiliary sideband port via register bits.

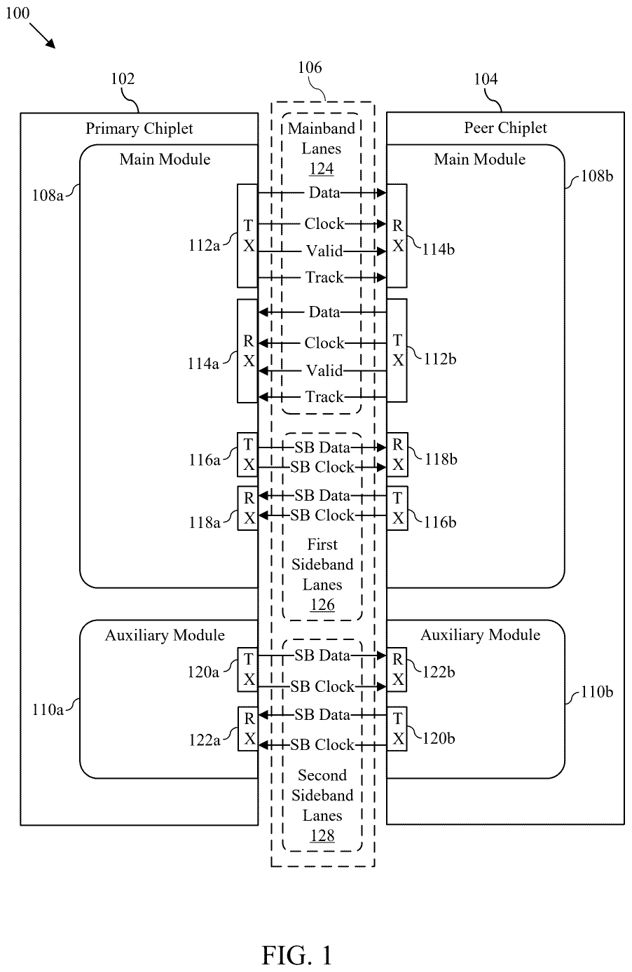

FIG. 1 is a schematic block diagram of an electronic system 100, in accordance with certain aspects of the present disclosure. The electronic system 100 may integrate multiple components, which are arranged to facilitate desired functions of the electronic system 100. The components may include chiplets, interconnects, system memory, clock circuitry, input/output interfaces, an interrupt handler, timing circuits, or the like. The electronic system 100 may include a primary chiplet 102 and a peer chiplet 104. The electronic system 100 may further include a plurality of communication lanes, for example, an interconnect 106. The primary chiplet 102 and the peer chiplet 104 are coupled to each other by way of the interconnect 106. The interconnect 106 may be a Universal Chiplet Interconnect express (UCIe) interconnect, and the primary chiplet 102 and the peer chiplet 104 may be referred to as UCIe chiplets.

A UCIe chiplet conforms to a UCIe specification to enable interoperability between UCIe chiplets. Further, the UCIe chiplets are coupled by way of UCIe interconnects. A UCIe chiplet typically includes three major layers or components conforming to the UCIe specification. The three layers are a physical layer, an adapter layer, and a protocol layer. The protocol layer defines a set of procedures for communication of data between the UCIe chiplets thereby ensuring seamless communication between chiplets manufactured by different vendors. The protocol layer further generates the data to be communicated on a UCIe interconnect. The UCIe interconnect may support high-speed data communication protocols such as a Peripheral Component Interconnect Express protocol, a Compute Express Link protocol, or the like.

The adapter layer in a chiplet converts data associated with a communication protocol of the chiplet to data packets for communication on the UCIe interconnect. In an example, two chiplets may adhere to different vendor-specific protocols. Thus, the adapter layer of each chiplet converts data packets adhering to the vendor-specific protocol to data packets compatible for transmission via the UCIe interconnect to a receiving chiplet. The physical (e.g., PHY) layer defines a mode of signaling associated with speed of data transmission, power consumption, and the like, between UCIe chiplets. Thus, the PHY layer acts as an interface between a UCIe chiplet and components external to the UCIe chiplet. An upgraded version of the previous UCIe specifications, e.g., the UCIe 2.0 specification, is described in the ongoing description.

Referring now to FIG. 1, the electronic system 100 may be a standard package, a combination of multiple standard packages, or the like. A standard package may integrate multiple chiplets on a single substrate or a single circuit board. The electronic system 100 may be included in an electronic device. Examples of the electronic device may include, but are not limited to, a cellular phone, a smartphone, a laptop, a notebook, a tablet, a phablet, a personal digital assistant, a satellite radio, a global positioning system device, a smart home device, intelligent lighting, a multimedia device, a video device, a digital audio player, a camera, a game console, an entertainment device, a vehicle component, a wearable computing device (e.g., a smartwatch, a health or fitness tracker, or eyewear), an appliance, a security device, a vending machine, a smart meter, or any other similar functioning device.

Each of the primary chiplet 102 and the peer chiplet 104 may include suitable circuitry, logic, interfaces, and/or codes executable by the circuitry, for executing applications, tasks, and/or instructions to perform functions associated with the primary chiplet 102 and the peer chiplet 104. In an example, the primary chiplet 102 and the peer chiplet 104 may be processing chiplets such that the primary chiplet 102 may be a general-purpose processing chiplet and the peer chiplet 104 may be a special-purpose processing chiplet. In further examples, the primary chiplet 102 may be a processor whereas the peer chiplet 104 may be a memory. The primary chiplet 102 and the peer chiplet 104 may be interconnected based on functions to be executed by the electronic system 100. In an example, to execute parallel processing of data, the primary chiplet 102 and the peer chiplet 104 may be interconnected. In further examples, the primary chiplet 102 and the peer chiplet 104 may be interconnected to store data in the peer chiplet 104 based on the processing of the data by the primary chiplet 102. The primary chiplet 102 and the peer chiplet 104 may be further interconnected based on a design of the electronic system 100 or the like.

In accordance with certain aspects of the present disclosure, the primary chiplet 102 may include a main module 108a and an auxiliary module 110a. Similarly, the peer chiplet 104 may also include a main module 108b and an auxiliary module 110b. The main module 108a and the main module 108b may be structurally and functionally similar. Further, the auxiliary module 110a and the auxiliary module 110b may be structurally and functionally similar. The main module 108a may include a mainband transmitter (denoted as “TX” in FIG. 1) 112a and a mainband receiver (denoted as “RX” in FIG. 1) 114a. The main module 108a may further include a sideband transmitter (denoted as “TX” in FIG. 1) 116a and a sideband receiver (denoted as “RX” in FIG. 1) 118a. Similarly, the main module 108b may include a mainband transmitter (denoted as “TX” in FIG. 1) 112b, a mainband receiver (denoted as “RX” in FIG. 1) 114b, a sideband transmitter (denoted as “TX” in FIG. 1) 116b, and a sideband receiver (denoted as “RX” in FIG. 1) 118b. The main module 108a may be communicatively coupled to the main module 108b. In an example, the mainband transmitter 112a is communicatively coupled to the mainband receiver 114b, the mainband receiver 114a is communicatively coupled to the mainband transmitter 112b, the sideband transmitter 116a is communicatively coupled to the sideband receiver 118b, and the sideband receiver 118a is communicatively coupled to the sideband transmitter 116b.

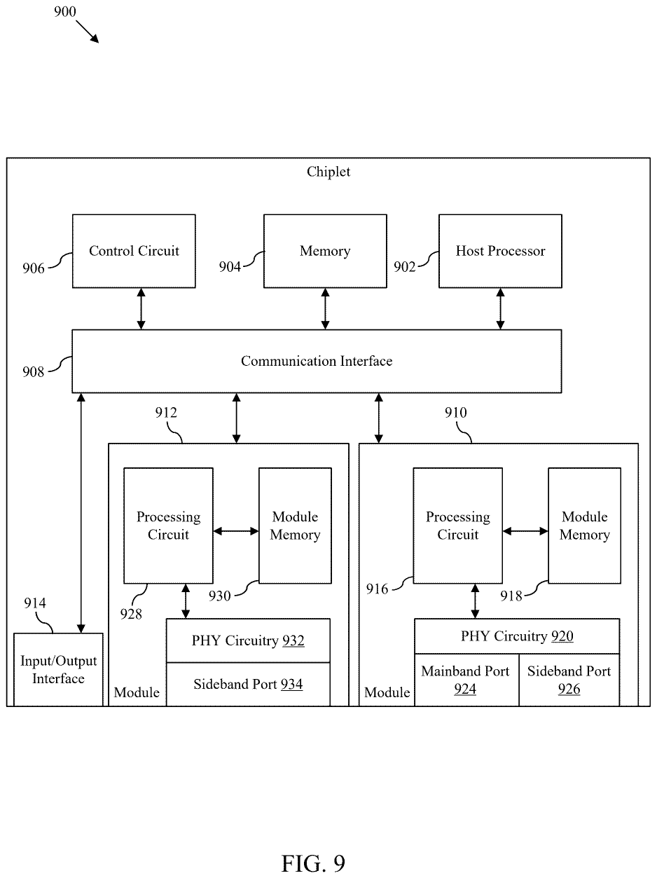

The auxiliary module 110a may include a sideband transmitter 120a and a sideband receiver 122a (denoted as “TX” 120a and “RX” 122a, respectively, in FIG. 1). Similarly, the auxiliary module 110b may include a sideband transmitter 120b and a sideband receiver 122b (denoted as “TX” 120a and “RX” 122b, respectively, in FIG. 1). The sideband transmitter 120a is communicatively coupled to the sideband receiver 122b, and the sideband receiver 122a is communicatively coupled to the sideband transmitter 120b. The various components of a UCIe chiplet (e.g., the primary chiplet 102 and the peer chiplet 104) are further depicted in FIG. 9. The sideband transmitter 120b and the sideband receiver 122b may be structurally similar to the sideband transmitter 120a and the sideband receiver 122a, respectively. Further, the sideband transmitter 120a and the sideband receiver 122a may be structurally similar to the sideband transmitter 116a and the sideband receiver 118a, respectively.

The mainband transmitter 112a and the mainband receiver 114a may be collectively referred to as a mainband port of the primary chiplet 102, and the sideband transmitter 116a and the sideband receiver 118a may be collectively referred to as a primary sideband port of the primary chiplet 102. Further, the sideband transmitter 120a and the sideband receiver 122b may be collectively referred to as an auxiliary sideband port of the primary chiplet 102. Thus, the main module 108a includes both a mainband port and a sideband port whereas the auxiliary module 110a includes a sideband port. In other words, the main module 108a may be configured to support sideband communication (e.g., support communication of sideband data) and mainband communication (e.g., support communication of mainband data) whereas the auxiliary module 110a may be configured to support sideband communication. In further aspects, the auxiliary module 110a may be configured to exclusively support sideband communication. In other words, the auxiliary module 110a may be referred to as sideband-only module.

Similar to the main module 108a and the auxiliary module 110a, the main module 108b includes both the mainband port (e.g., the mainband transmitter 112b and the mainband receiver 114b) and the sideband port (e.g., the sideband transmitter 116b and the sideband receiver 118b) whereas the auxiliary module 110b includes a sideband port (e.g., the sideband transmitter 120b and the sideband receiver 122b). Further, the main module 108b may be configured to support sideband communication and mainband communication whereas the auxiliary module 110b may be configured to support sideband communication.

The interconnect 106 includes a set of mainband lanes 124, one or more first sideband lanes 126, and one or more second sideband lanes 128. The mainband transmitter 112a and the mainband receiver 114a may be coupled to the mainband receiver 114b and the mainband transmitter 112b, respectively, via the set of mainband lanes 124 whereas the sideband transmitter 116a and the sideband receiver 118a may be coupled to the sideband receiver 118b and the sideband transmitter 116b, respectively, via the one or more first sideband lanes 126. Further, the sideband transmitter 120a and the sideband receiver 122b may be coupled to the sideband receiver 122b and the sideband transmitter 120b, respectively, via the one or more second sideband lanes 128.

The set of mainband lanes 124 may include data lanes, clock lanes, valid lanes, track lanes, or the like. The data lanes, clock lanes, valid lanes, and track lanes are associated with a mainband transmitter-receiver pair, e.g., the mainband transmitter 112a and the mainband receiver 114b, and the mainband transmitter 112b and the mainband receiver 114a. A number of the data lanes may be based on a type of a package that includes the primary chiplet 102 and the peer chiplet 104. In an example, in a standard package, each clock lane associated with each mainband transmitter-receiver pair may include two clock lines, e.g., a P clock line and an N clock line. Further, the data lanes associated with each mainband transmitter-receiver pair may include 16 transmit data lines and 16 receive data lines.

The set of mainband lanes 124 may be configured to communicate the mainband data between the primary chiplet 102 and the peer chiplet 104. The mainband data may refer to at least one of training data and operational data that may be associated with an application to be executed on the primary chiplet 102 and the peer chiplet 104. Thus, based on each application, the training data and the operational data may vary. The applications may be associated with one of processing an image, training a machine learning model, feature extractions from an audio/video, or the like, to execute one or more operations associated with the electronic system 100. During the training of the set of mainband lanes 124, the mainband data may correspond to training data. Further, when the set of mainband lanes 124 may be trained, the mainband data may correspond to operational data. In other words, the set of mainband lanes 124 may be trained prior to the communication of the operational data via the set of mainband lanes 124. The operational data may include read/write data, payloads, instructions, or the like, that may be associated with the application.

The training data may be indicative of mainband-lane training parameters that may be communicated between the primary chiplet 102 and the peer chiplet 104 via at least one of the set of mainband lanes 124. Based on the training data, capabilities of each of the set of mainband lanes 124, the primary chiplet 102, and the peer chiplet 104 may be identified in ensuring a seamless communication of the operational data via the set of mainband lanes 124. The training data may thus include voltage configurations to configure voltage levels associated with the communication of the operational data in the primary chiplet 102 and the peer chiplet 104, timing of the communication of the operational data, data rates associated with the communication of the operational data between the primary chiplet 102 and the peer chiplet 104, verification commands to identify the communication protocol supported by the primary chiplet 102 and the peer chiplet 104, and the like.

Upon successful training of the set of mainband lanes 124, the set of mainband lanes 124 may be activated for the communication of the operational data between the primary chiplet 102 and the peer chiplet 104. In other words, based on the training of the set of mainband lanes 124, each of the data lanes, clock lanes, valid lanes, and track lanes are configured to communicate data associated with the corresponding lane. In an example, the data lanes are configured to communicate a payload of the operational data between the primary chiplet 102 and the peer chiplet 104 whereas the clock lanes synchronize the communication of the operational data between the primary chiplet 102 and the peer chiplet 104. The valid lane may indicate that the payload communicated on the data lanes may be valid for further processing. Further, the track lane may be utilized to monitor a status of the payload on the data lanes.

The one or more first sideband lanes 126 includes data lanes and clock lanes. The data lanes and clock lanes are associated with each sideband transmitter-receiver pair, e.g., the sideband transmitter 120a and the sideband receiver 122b, and the sideband receiver 122a and the sideband transmitter 120b. The one or more first sideband lanes 126 are configured to communicate first data (denoted as “SB data” and “SB clock” in FIG. 1) between the primary chiplet 102 and the peer chiplet 104. In an example, the data lanes are configured to communicate the SB data between the primary chiplet 102 and the peer chiplet 104 whereas the clock lanes synchronize the communication of the SB data by way of the SB clock between the primary chiplet 102 and the peer chiplet 104. Thus, the clock lanes communicate SB clock data between the primary chiplet 102 and the peer chiplet 104.

The first data may refer to any sideband data that may be communicated by the primary sideband port via the one or more first sideband lanes 126. The first data, e.g., the sideband data, may include control commands (e.g., one or more control parameters) associated with configuration of communication parameters in the primary chiplet 102 and the peer chiplet 104 to synchronize the communication of the mainband data between the primary chiplet 102 and the peer chiplet 104. Further stated, the first data may be associated with controlling the operational data (e.g., the mainband data) by way of control parameters to ensure seamless communication of the operational data between the primary chiplet 102 and the peer chiplet 104.

Prior to the training of the set of mainband lanes 124, the one or more first sideband lanes 126 are trained (e.g., initialized). During training of the one or more first sideband lanes 126, the first data may include discovery requests to detect the peer chiplet 104 coupled to the one or more first sideband lanes 126, addresses of memory locations in the primary chiplet 102 and the peer chiplet 104 to store the sideband data, communication capabilities associated with a communication protocol of the sideband data, synchronization of clock domains of the primary chiplet 102 and the peer chiplet 104, and the like.

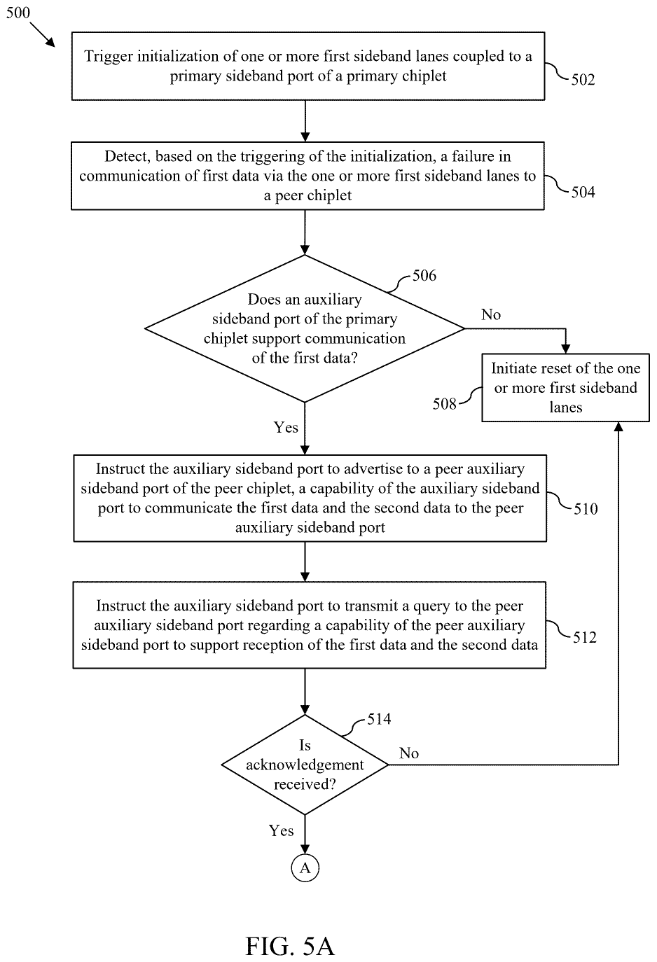

Upon successful training of the one or more first sideband lanes 126, the training of the set of mainband lanes 124 occurs. Further, upon successful training of the set of mainband lanes 124, the first data may further be associated with handling of errors and ensuring smooth operation in the communication of the operational data (e.g., the mainband data) via the set of mainband lanes 124, monitoring of the operational data, and the like. Thus, the first data may be further based on the applications to be executed on the primary chiplet 102 and the peer chiplet 104. The training of the interconnect 106 (e.g., the set of mainband lanes 124 and the one or more first sideband lanes 126) has been explained in detail in FIG. 4.

Referring now to the UCIe 2.0 specification, the UCIe 2.0 specification is an upgraded version of the previous UCIe specifications. The UCIe 2.0 specification further defines advanced power and bandwidth management solutions, and various testing and debug techniques. In addition, various package designs (such as 3D packaging in addition to the 2D and 2.5D packages) are supported by the UCIe 2.0 specification. Further, the UCIe 2.0 specification is fully backward compatible with the previous UCIe specifications.

The UCIe 2.0 specification defines a sideband module that supports a sideband port for communication of management data between the UCIe chiplets via sideband lanes. The management data may be associated with an overall operation (e.g., management functions) of the interconnected chiplets and may not be directly associated with the communication of the mainband data between the chiplets. The management data may thus include one or more management parameters associated with various management functions such as installation of firmware in the chiplets, communication of debug data, power and thermal management data, performance monitoring, encryption and integrity data to prevent tampering or corruption, debug data, error reporting, telemetry data, and the like, between the chiplets. The management data may be communicated at defined intervals via sideband lanes of the UCIe interconnect whereas for the remaining time the sideband lanes remain idle. The defined time intervals may be based on the updates to a package that includes the chiplets. Though the system and method described herein are associated with the UCIe 2.0 specification; however, the scope of the disclosure is not limited to it. The system and method may be applicable to any future versions of UCIe.

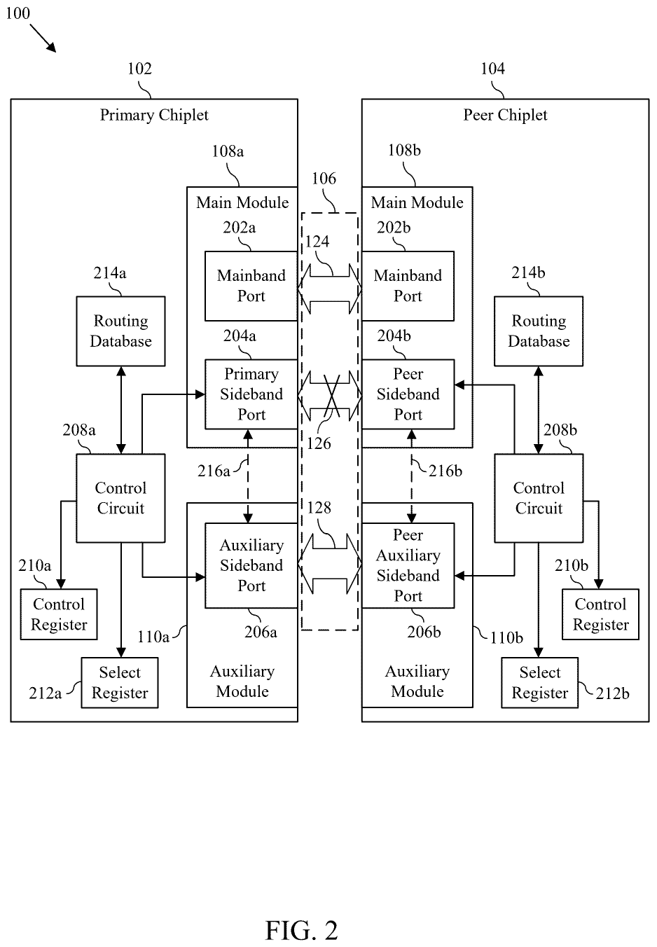

In reference to FIG. 1, the management data may be second data that includes management parameters associated with the management functions of the primary chiplet 102 and the peer chiplet 104. Further, the sideband module and the sideband port that communicate the management data may be the auxiliary module 110a and the auxiliary sideband port (e.g., the sideband transmitter 120a and the sideband receiver 122a), respectively, and the sideband lanes of the sideband port may be the one or more second sideband lanes 128. The management data may be generated by the auxiliary module 110a based on management commands received from a control circuit (shown in FIG. 2) of the primary chiplet 102. Further, the control circuit may generate and provide the management commands to the auxiliary module 110a based on management instructions received from the host processor of the primary chiplet 102.

The one or more second sideband lanes 128 may be trained to communicate the second data between the primary chiplet 102 and the peer chiplet 104. Further, the one or more second sideband lanes 128 may be trained prior to the training of the one or more first sideband lanes 126 or after the training of the one or more first sideband lanes 126. The one or more second sideband lanes 128 may be structurally similar to the one or more first sideband lanes 126. Thus, the one or more second sideband lanes 128 may be configured to communicate corresponding SB data and SB clock associated with the management data. Further, the SB data and the SB clock as shown in FIG. 1, may be communicated between each sideband transmitter-receiver pair (e.g., the sideband transmitter 120a and the sideband receiver 122b and the sideband transmitter 120b and the sideband receiver 122a).

In a scenario, one of the primary chiplet 102 and the peer chiplet 104 may trigger the training of the set of mainband lanes 124 and the one or more first sideband lanes 126 with the other chiplet to execute an application on each of the primary chiplet 102 and the peer chiplet 104. In a non-limiting example, it is assumed that the primary chiplet 102 may trigger the training; however, in various other aspects, the peer chiplet 104 can also trigger the training. Further, a host controller of the electronic system 100 may instruct the primary chiplet 102 to trigger the training of the interconnect 106.

To initiate the training, the first data may be assigned to the primary sideband port of the main module 108a for communication to the peer chiplet 104 via the one or more first sideband lanes 126. However, a failure may occur in the communication of the first data via the one or more first sideband lanes 126. The failure in the communication of the first data may refer to a failure in a communication of at least one control command associated with the first data via the one or more first sideband lanes 126. In one aspect, the one or more first sideband lanes 126 may become faulty due to mechanical wear and tear, aging, thermal degradation, or the like, thereby resulting in the failure. In further aspects, the sideband port may be defective or unable to communicate the first data via the one or more first sideband lanes 126, thereby resulting in the failure. Thus, the primary chiplet 102 detects a failure of the communication of the first data to the peer chiplet 104 via the one or more first sideband lanes 126.

Based on the failure to communicate the first data via the one or more first sideband lanes 126, the present disclosure allows repurposing (e.g., reconfiguring) of the auxiliary sideband port (e.g., the sideband transmitter 120a and the sideband receiver 122a) to communicate the first data in addition to the second data. In other words, the auxiliary sideband port of the primary chiplet 102 is reconfigured to communicate the first data in addition to the second data via the one or more second sideband lanes 128 to the peer chiplet 104 as explained in detail in FIG. 2. Further, based on the reconfigured auxiliary sideband port of the primary chiplet 102, the communication of the first data and the second data via the one or more second sideband lanes 128 to the peer chiplet 104 is controlled.

FIG. 2 illustrates a block diagram of the primary chiplet 102 and the peer chiplet 104, in accordance with certain aspects of the present disclosure. The primary chiplet 102 includes the main module 108a and the auxiliary module 110a as described in FIG. 1. The main module 108a includes the mainband port 202a and the primary sideband port 204a. The mainband port 202a may correspond to the mainband transmitter 112a and the mainband receiver 114a, the primary sideband port 204a may correspond to the sideband transmitter 116a and the sideband receiver 118a, and the auxiliary sideband port 206a may correspond to the sideband transmitter 120a and the sideband receiver 122a. The primary chiplet 102 may further include the control circuit 208a, a control register 210a, a select register 212a, and a routing database 214a. Further, the peer chiplet 104 may include the mainband port 202b, the peer sideband port 204b, the peer auxiliary sideband port 206b, the control circuit 208b, a control register 210b, a select register 212b, and a routing database 214b. The peer auxiliary sideband port 206b may be structurally and functionally similar to the auxiliary sideband port 206a. For the sake of explaining FIG. 2 and without deviating from the scope of the disclosure, in a non-limiting example, it is assumed that the primary chiplet 102 is configured to initiate communication with the peer chiplet 104.

In one aspect, to execute one or more applications associated with the electronic system 100, a central processing unit of the electronic system 100 instructs the primary chiplet 102 (e.g., a host controller of the primary chiplet 102) to initiate the communication with the peer chiplet 104. In further aspects, the host controller of the primary chiplet 102 may self-initiate the communication with the peer chiplet 104 to enable parallel execution of applications between the primary chiplet 102 and the peer chiplet 104. In further aspects, upon powering ON the electronic system 100, the primary chiplet 102 may be triggered by default to initiate the communication with the peer chiplet 104. In any of the above aspects, the host controller may instruct the control circuit 208a to control the communication with the peer chiplet 104. The instructions to the control circuit 208a to control the communication may be indicative of the application to be executed on the primary chiplet 102 and the peer chiplet 104, parameters associated with the application to achieve a desired operation of the electronic system 100, and the like.

Based on the instructions received from the host processor, the control circuit 208a may identify an available module of the primary chiplet 102 to establish the communication with the peer chiplet 104. In one aspect, the control circuit 208a may identify the main module 108a as the available module. In an example, the main module 108a may be idle at the time of identification. In further aspects, the main module 108a may be a default module to establish the communication with the peer chiplet 104. Based on the identification of the main module 108a, the control circuit 208a may inquire with the main module 108a regarding capabilities of the main module 108a to establish the communication with the peer chiplet 104. The capabilities may be associated with communication protocols, data rate, speed of operation, or the like, that may be handled by the main module 108a.

The main module 108a may provide a response indicating the capabilities of the main module 108a to the control circuit 208a. Based on the received response, the control circuit 208a may detect that the capabilities of the main module 108a cater to the establishment of the communication with the peer chiplet 104. The control circuit 208a may thus select the main module 108a to establish the communication with the peer chiplet 104 and notify the main module 108a regarding the selection.

The control circuit 208a may further generate and provide setup commands based on the instructions received from the host processor to the main module 108a. Based on the reception of the setup commands, the main module 108a may store the setup commands in a memory associated with the main module 108a. The control circuit 208a may be further configured to trigger the initialization of the one or more first sideband lanes 126 (e.g., train the one or more first sideband lanes 126) to initiate the communication with the peer chiplet 104 via the main module 108a.

In one aspect, the main module 108a may generate the first data based on the setup commands to initialize the one or more first sideband lanes 126. In further aspects, the control circuit 208a may generate the first data and provide the first data to the main module 108a. Upon receiving the first data, the main module 108a may translate the first data into a format compatible for communication via the one or more first sideband lanes 126. The main module 108a may thus be configured for initiating the communication with the peer chiplet 104 via the one or more first sideband lanes 126. In an example, the main module 108a may configure the primary sideband port 204a to communicate the first data (e.g., map the primary sideband port 204a with the first data) to the peer sideband port 204b via the one or more first sideband lanes 126. Based on the mapping of the first data to the primary sideband port 204a, the control circuit 208a may configure the routing database 214a to indicate the communication of the first data via the primary sideband port 204a. In further aspects, the control circuit 208a may configure the routing database 214a via the main module 108a. The first data may be indicative of control data to initialize the one or more first sideband lanes 126 as explained in FIG. 4.

In a scenario, the one or more first sideband lanes 126 may be faulty (denoted by “X” in FIG. 2). Thus, a failure may occur in the communication of the first data via the one or more first sideband lanes 126. In one aspect, the main module 108a may indicate the failure of the communication to the control circuit 208a. The control circuit 208a may thus detect the failure in the communication via the one or more first sideband lanes 126. In further aspects, the control circuit 208a may detect the failure in the communication via the one or more first sideband lanes 126 based on a failure to receive an indication from the main module 108a regarding a successful communication of the first data via the one or more first sideband lanes 126.

Based on the detection of the failure, the control circuit 208a may be further configured to identify a presence of another sideband port in the primary chiplet 102 to communicate the first data to the peer chiplet 104. In further aspects, the main module 108a may indicate the control circuit 208a regarding the failure and initiate a request to identify the presence of another sideband port to communicate the first data. Thus, the control circuit 208a based on the failure, may be configured to identify a presence of the auxiliary sideband port 206a in the primary chiplet 102.

The auxiliary sideband port 206a may be identified based on the structural similarity of the auxiliary sideband port 206a with the primary sideband port 204a. In one aspect, the primary sideband port 204a and the auxiliary sideband port 206a may both be configured to support low bandwidth and low power data communication. In an example, a low bandwidth may refer to 100 Megabits per second (Mbps) and a low power may refer to 250 PicoJoules/bit (pJ/bit). As both the first data and the second data require low bandwidth and low power for communication with the peer chiplet 104, the auxiliary sideband port 206a may be able to support the first data.

The control circuit 208a may be further configured to determine, whether the auxiliary sideband port 206a supports the communication of the first data. The control circuit 208a may further read one or more first bits of the control register 210a that indicate whether the auxiliary sideband port 206a supports the communication of the first data. The one or more first bits of the control register 210a may indicate to the control circuit 208a that the auxiliary sideband port 206a supports the communication of the first data. In an example, the one or more first bits may be set by the control circuit 208a or the host processor of the primary chiplet 102 based on the presence of the auxiliary sideband port 206a in the primary chiplet 102. In addition, the one or more first bits may be set based on structural and functional similarity of the auxiliary sideband port 206a with the primary sideband port 204a. The one or more first bits of the control register 210a may be set during power-ON. In further aspects, based on the detection of the failure, the control circuit 208a may read the one or more first bits of the control register 210a to identify the presence of the auxiliary sideband port 206a that supports the communication of the first data.

Upon determining that the auxiliary sideband port 206a supports the communication of the first data, the control circuit 208a may further read bits of the select register 212a associated with the auxiliary sideband port 206a to determine whether the auxiliary sideband port 206a is capable to multiplex the first data and the second data. The capability to multiplex the first data and the second data may be indicative of a capability to communicate both the first data and the second data via the one or more second sideband lanes 128. The bits of the select register 212a may be set to indicate that the auxiliary sideband port 206a is capable to multiplex the first data and the second data.

The bits of the select register 212a may be set during power-ON of the electronic system 100. Further, the bits of the select register 212a may be set by the control circuit 208a or the host processor of the primary chiplet 102. In one aspect, a design of the primary chiplet 102 may enable the auxiliary sideband port 206a to multiplex the first data and the second data. The primary chiplet 102 may include a Network-On-Chip (NoC) interface (indicated by dotted line 216a in FIG. 2) that couples the main module 108 a to the auxiliary module 110a thereby enabling provision of the first data from the main module 108a to the auxiliary module 110a. Further stated, a routing circuit of the NoC interface may provide a path to route the first data from the main module 108a to the auxiliary module 110a. In addition, the NoC interface may include a multiplexing logic such as a multiplexer or switching circuit thereby enabling the multiplexing of the first data and the second data. In an example, the multiplexer may be configured to receive the first data and the second data as inputs. In further examples, the switching circuitry may be configured to switch between the first data and the second data. The multiplexer and the switching circuitry may be controlled by the control circuit 208a. The multiplexing of the first data and the second data is explained in further detail in the ongoing description.

Upon determining that the auxiliary sideband port 206a is capable to multiplex the first data and the second data based on the select register 212a, the control circuit 208a may be further configured to instruct the auxiliary sideband port 206a via the auxiliary module 110a to advertise (e.g., transmit) to the peer auxiliary sideband port 206b of the peer chiplet 104, the capability of the auxiliary sideband port 206a to communicate the first data in addition to the second data. Such capability advertisement (or transmission) of the auxiliary sideband port 206a may occur via the one or more second sideband lanes 128. In one aspect, the capability advertisement may include transmission of a notification indicating the capability of the auxiliary sideband port 206a for the communication of the first data and the second data. The control circuit 208a may further control the auxiliary sideband port 206a to transmit the notification during the advertisement. The peer chiplet 104 (e.g., the control circuit 208b) may identify that the auxiliary sideband port 206a is capable to communicate the first data in addition to the second data based on the notification received during the advertisement. The peer chiplet 104 (e.g., the control circuit 208b) may further confirm a reception of the notification (e.g., provide a confirmation) to the primary chiplet 102 (e.g., the control circuit 208a) via the peer auxiliary sideband port 206b, the one or more second sideband lanes 128, and the auxiliary sideband port 206a.

Upon receiving the confirmation, the control circuit 208a may be further configured to instruct the auxiliary sideband port 206a via the auxiliary module 110a to transmit a query to the peer auxiliary sideband port 206b regarding a capability of the peer auxiliary sideband port 206b to support reception of the first data in addition to the second data. In one aspect, the control circuit 208a may instruct the main module 108a to generate the query. In further aspects, the control circuit 208a may generate the query and provide the query to the main module 108a. In various aspects, the query may be transmitted during the advertisement. The auxiliary sideband port 206a may thus transmit the query. Further, the query may be transmitted via the one or more second sideband lanes 128.

Upon transmitting the query to the peer auxiliary sideband port 206b, the control circuit 208a waits for a time duration to receive an acknowledgement from the peer chiplet 104 by way of the peer auxiliary sideband port 206b regarding the capability of the peer auxiliary sideband port 206b to support the reception of the first data in addition to the second data. If the peer auxiliary sideband port 206b is configured to support the reception of the first data in addition to the second data, the control circuit 208b may generate the acknowledgement indicating the capability. The control circuit 208a may instruct the peer auxiliary sideband port 206b to provide the acknowledgement regarding the capability of the peer auxiliary sideband port 206b to support the reception of the first data in addition to the second data.

The determination of the capability of the peer auxiliary sideband port 206b occurs in a manner similar to the determination of the capability of the auxiliary sideband port 206a (e.g., via one or more first bits of the control register 210b and the select register 212b) as explained in the foregoing disclosure. The peer auxiliary sideband port 206b may provide the acknowledgement to the auxiliary sideband port 206a, based on the query. Thus, the control circuit 208a may receive the acknowledgement within the time duration via the auxiliary sideband port 206a. In various aspects, if the peer auxiliary sideband port 206b is unable to support the reception of the first data in addition to the second data, the control circuit 208b may be unable to generate the acknowledgement. The control circuit 208a may thus detect the absence of the reception of the acknowledgement in the time duration. In such an event, the control circuit 208a may detect that the peer auxiliary sideband port 206b is unable to support the reception of the first data in addition to the second data. In such a scenario, the control circuit 208a may initiate a reset operation of the primary chiplet 102. However, as the peer auxiliary sideband port 206b and the auxiliary sideband port 206a are functionally similar, the peer auxiliary sideband port 206b may be able to support the reception of the first data. Thus, the control circuit 208a may receive the acknowledgement within the time duration. The peer chiplet 104 may further include a NoC interface (indicated by a dotted line 216b in FIG. 2) that may be similar to the NoC interface 216a.

Upon receiving the acknowledgement, the control circuit 208a may select the auxiliary sideband port 206a for the communication of the first data and the second data. The control circuit 208a may be further configured to set one or more second bits of the control register 210a to reconfigure the auxiliary sideband port 206a for the communication of the first data and the second data. In addition, the control circuit 208b may be further configured to set the one or more second bits of the control register 210b to reconfigure the peer auxiliary sideband port 206b for the reception of the first data and the second data upon providing the acknowledgement. The control circuit 208a may be further configured to update the routing database 214a to indicate the communication of the first data via the auxiliary sideband port 206a, in addition to the communication of the second data via the auxiliary sideband port 206a.

The control circuit 208a may further instruct the main module 108a to execute a handshake with the auxiliary module 110a to provide the first data to the auxiliary module 110a. The main module 108a may be further configured to map the auxiliary sideband port 206a of the auxiliary module 110a with the first data to provide the first data via the NoC interface. The provision of the first data may be controlled by the control circuit 208a. In one aspect, the handshake may be executed via the NoC interface. In an example, to execute the handshake, the first data that may adhere to a UCIe communication protocol (as mentioned in FIG. 9) may be converted by the main module 108a, to a first data packet adhering to an NoC protocol. The first data packet may further be routed to the auxiliary sideband port 206a via the NoC interface. The first data packet may be extracted by the auxiliary module 110a and reconverted back to the first data that may adhere to the UCIe protocol for communication on the one or more second sideband lanes 128. In addition, the one or more second bits of the select register 212a may be updated with a memory location of the primary sideband port 204a indicating the provision of the first data to the auxiliary sideband port 206a. Due to routing of the first data from the main module 108a to the auxiliary module 110a, a latency in the regeneration of the first data may be avoided as the setup commands associated with the generation of the first data are stored in the memory of the main module 108a. However, in further aspects, the setup commands may be provided to the auxiliary module 110a from the main module 108a or the control circuit 208a, upon reconfiguring the auxiliary sideband port 206a. The auxiliary module 110a may thus generate the first data and the first data may be at least partially erased from the main module 108a. The main module 108a and the auxiliary module 110a may further work in conjunction for the synchronization of the first data with the mainband data.

The control circuit 208a may be further configured to assign a priority to each of the first data and the second data based on an arbitration logic. The arbitration logic may be based on one or more tasks to be executed on the primary chiplet 102 and the peer chiplet 104. In other words, based on the task to be executed, one of the first data or the second data may be assigned with a higher priority level or a lower priority level. The higher priority level may take precedence over the lower priority level. The host processor of the primary chiplet 102 may determine the task to be executed on the primary chiplet 102. The task may be associated with at least one of the execution of the applications on the primary chiplet 102 and the peer chiplet 104 or configuration of the management parameters in the primary chiplet 102 and the peer chiplet 104. In an example, to transition the primary chiplet 102 and the peer chiplet 104 from different power states, the second data may be assigned with the higher priority level. In further examples, to process the mainband data associated with execution of a critical operation (e.g., deployment of an airbag in an automobile) on the peer chiplet 104, the first data may be assigned with the higher priority level to control the mainband data.

Thus, the control circuit 208a may be configured to arbitrate between the first data and the second data to prioritize either the first data or the second data. In further aspects, the control circuit 208a may prioritize the first data based on a default prioritization of the first data. In various aspects, the second data may be prioritized with the default prioritization. In such aspects, the first data may be on hold until the communication of the second data is complete, and the first data may be communicated upon the communication of the second data.

The control circuit 208a may be further configured to timeshare the auxiliary sideband port 206a between the first data and the second data based on the assigned priority. In other words, the timesharing between the first data and the second data may be based on the task to be executed on each of the primary chiplet 102 and the peer chiplet 104. In an example, the communication via the auxiliary sideband port 206a may be split into time slots such that each of the main module 108a and the auxiliary module 110a may be assigned specific slots on the communication for providing the first data and the second data, respectively, to the auxiliary sideband port 206a. Further, one of the first data or the second data that has the higher priority level may be assigned with an earlier time slot whereas the data having the lower priority level may be assigned with a later time slot. Thus, the auxiliary module 110a may transmit one of the first data and the second data on the shared auxiliary sideband port 206a at any given time instance thereby eliminating a simultaneous provision of the first data and the second data to the auxiliary sideband port 206a. In further aspects, the arbitration logic may be based on a round-robin scheduling scheme.

Thus, the control circuit 208a may be configured to control, based on the reconfigured auxiliary sideband port 206a, the communication of the first data in addition to the second data via the one or more second sideband lanes 128 to the peer chiplet 104. Each of the first data and the second data may be thus communicated one at a time via the one or more second sideband lanes 128. Similarly, the peer chiplet 104 may reconfigure the peer auxiliary sideband port 206b to communicate first data and second data associated with the peer chiplet 104 in response to the reception of the first data and the second data associated with the primary chiplet 102. Further, the set of mainband lanes 124 may be initialized for training based on the reconfiguration of the auxiliary sideband port 206a. Upon the training of the set of mainband lanes 124, the first data and the second data are thus routed via the auxiliary sideband port 206a. Further, in various aspects, when the peer chiplet 104 may be triggered to initiate the training of the interconnect 106, the peer chiplet 104 may be configured to execute the operations of the primary chiplet 102 as explained in the foregoing disclosure.

Though the control register 210a and the select register 212a are shown to be external to the auxiliary module 110a, in various aspects, the control register 210a and the select register 212a may be internal to the auxiliary module 110a.

Though the control circuit 108a is shown external to the main module 108a and the auxiliary module 110a, in various aspects, the control circuit 208a may be included in either of the main module 108a or the auxiliary module 110a.

In various aspects, the control circuit 108a may configure the auxiliary sideband port 206a prior to the detection of the failure.

It will be understood by a person skilled in the art that though the primary chiplet 102 and the peer chiplet 104 are shown to be included in the electronic system 100, the electronic system 100 may include more than two chiplets that may be interconnected in a manner similar to the interconnection of the primary chiplet 102 and the peer chiplet 104 to achieve the desired operations of the electronic system 100.

In further aspects, multiple chiplets may be interconnected to each of the primary chiplet 102 and the peer chiplet 104. Further, if a sideband lane fails, the auxiliary sideband port of the chiplets may be utilized to communicate the sideband data between the chiplets. In further aspects, each of the primary chiplet 102 and the peer chiplet 104 may include more than one auxiliary module.

In an advanced package that may include redundant lanes, if the redundant lanes are faulty, the auxiliary module of the chiplets of the advanced package may be utilized for the communication of the sideband data.

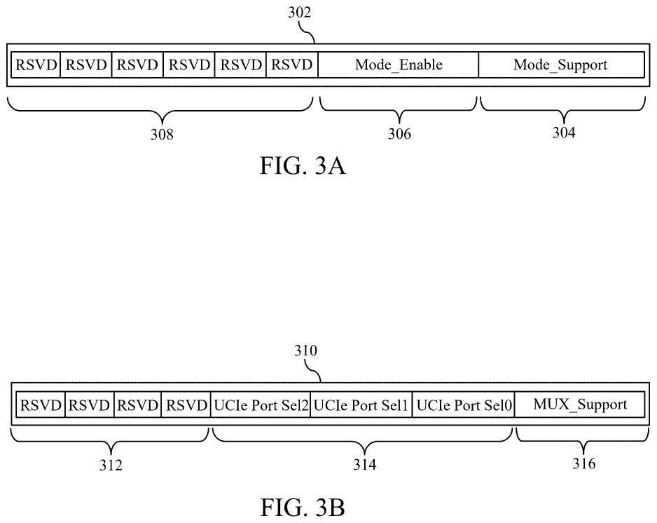

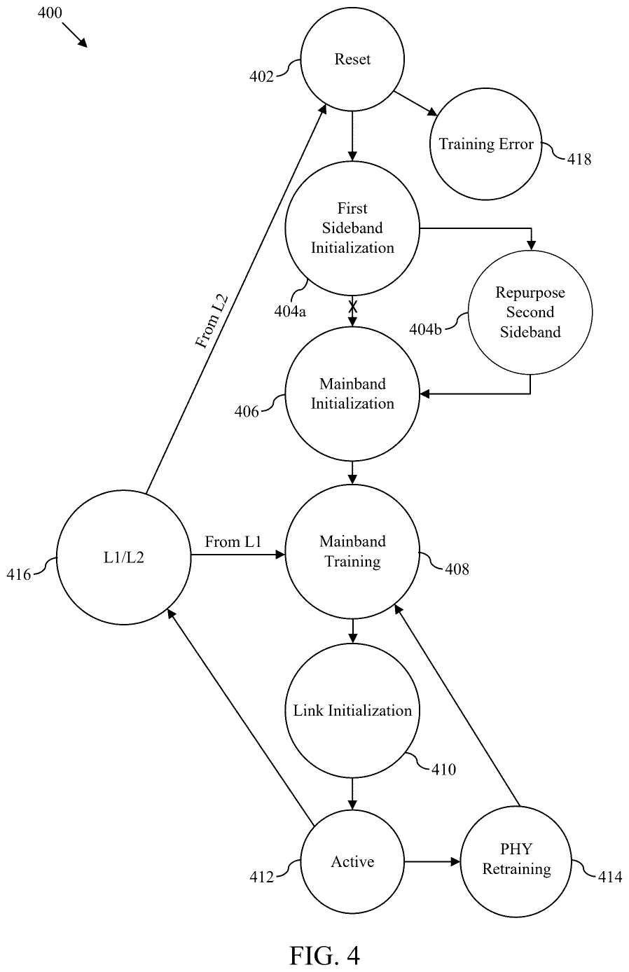

FIG. 3A illustrates a control register 302 of a chiplet in an electronic system 100 of FIG. 1, in accordance with certain aspects of the present disclosure. The control register 302 of FIG. 3A is shown to be same as the control register 210a of FIG. 2. Further, the chiplet that includes the control register 302 may be the primary chiplet 102. The control register 302 may be coupled to the control circuit 208a. Further, the control register 302 may be associated with the auxiliary module 110a. The control register 302 may include a plurality of bits. One or more first bits 304 of the plurality of bits of the control register 302 are set to indicate that the auxiliary sideband port 206a may support the communication of the first data. In an example, the one or more first bits 304 may be set to a logic high state (1) to indicate that the auxiliary sideband port 206a may support the communication of the first data. In various other examples, the one or more first bits 304 may be set to a logic low state (0). Thus, the control circuit 208a may determine whether the auxiliary sideband port 206a supports the communication of the first data based on the one or more first bits 304. The control circuit 208a or the host processor of the primary chiplet 102 may set the one or more first bits 304 of the control register 302. The one or more first bits 304 are denoted by “Mode_Support” in FIG. 3A.

One or more second bits 306 of the plurality of bits are set by the control circuit 208a to reconfigure the auxiliary sideband port 206a. In other words, the control circuit 208a may set the one or more second bits 306, upon the detection of the failure, to reconfigure the auxiliary sideband port 206a for the communication of the first data and the second data. In an example, the one or more second bits 306 may be at logic low state (0) prior to the reconfiguration. Thus, the control circuit 208a may set the one or more second bits 306 to a logic high state (1) to reconfigure the auxiliary sideband port 206a for the communication of the first data and the second data. The control circuit 208a may set the one or more second bits 306 of the control register 302 based on the reception of the acknowledgement from the peer chiplet 104 that is indicative of the peer auxiliary sideband port 206b having the capability to support the reception of the first data. The one or more second bits 306 are denoted by “Mode_Enable” in FIG. 3A. The control register 302 may further include one or more reserved bits (denoted by “RSVD” in FIG. 3A) 308 that may be reserved for future operations of the auxiliary module 110a. In various aspects, the control register 302 of FIG. 3A may be same as the control register 210b of FIG. 2.

FIG. 3B illustrates a select register 310 of a chiplet of the electronic system 100 of FIG. 1, in accordance with certain aspects of the present disclosure. The select register 310 of FIG. 3B is shown to be same as the select register 212a of FIG. 2. Further, the chiplet that includes the select register 310 may be the primary chiplet 102. Further, the select register 310 may be associated with the auxiliary module 110a.

The select register 310 of FIG. 3B is shown to include a first set of reserved bits (denoted by “RSVD” in FIG. 3B) 312, a second set of port bits (denoted by “UCIe Port Sel2, UCIe Port Sel1, and UCIe Port Sel0” in FIG. 3B) 314, and a third set of select bits (denoted by “MUX_Support” in FIG. 3B) 316. The first set of reserved bits 312 may be reserved for future operations of the auxiliary module 110a. The second set of port bits 314 may be indicative of a port that is multiplexing with the auxiliary sideband port 206a. In an example, the primary chiplet 102 may include 8 ports. Thus, the second set of port bits 314 may include 3 bits to indicate each of the 8 ports. Further, the second set of port bits 314 may be indicative of ‘001’ indicating that the primary sideband port 204a may be selected to multiplex with the auxiliary sideband port 206a. It will be understood by a person skilled in the art that for more than 8 ports, the second set of port bits 314 may include more than 3 bits. In other words, the primary sideband port 204 a may provide the first data to the auxiliary sideband port 206a.

The third set of select bits 316 may be indicative of the capability of the auxiliary sideband port 206a to multiplex the first data and the second data. The control circuit 208a may read the third set of select bits 316 to determine whether the auxiliary sideband port 206a has the capability to multiplex the first data and the second data. The third set of select bits 316 may be set to indicate that the auxiliary sideband port 206a has the capability to multiplex the first data and the second data. In an example, the third set of select bits 316 may be to a logic high state (1) to indicate that the auxiliary sideband port 206a has the capability to multiplex the first data and the second data. In various aspects, the select register 310 of FIG. 3B may be same as the select register 212b of FIG. 2.

FIG. 4 is a state machine 400 that illustrates various states to activate the interconnect 106 for communication of the first data and the second data to the peer chiplet 104 in accordance with certain aspects of the present disclosure. FIG. 4 is described in conjunction with FIGS. 1, 2, 3A, and 3B. The states may be controlled by the control circuit 208a. The interconnect 106 may be trained to establish reliable communication between the primary chiplet 102 and the peer chiplet 104. The training of the interconnect 106 may occur based on power-ON of the electronic system 100, failure of data communication via the interconnect 106, an interrupt or a reset initiated by the host controller of the primary chiplet 102 and the peer chiplet 104, reconfiguration of the interconnect 106, or the like. The state machine 400 may transition between various states such as a reset state 402, a first sideband initialization state 404a, a repurpose second sideband state 404b, a mainband initialization state 406, a mainband training state 408, a link initialization state 410, an active state 412, a PHY retraining state 414, a sleep or low power (L1/L2) state 416, and a training error state 418. The training of the interconnect 106 is explained in reference to the primary chiplet 102; however, the role of the peer chiplet 104 in training the interconnect 106 will be understood by a person skilled in the art.

Referring now to the reset state 402, the reset state 402 may be a default state of the state machine 400 that may occur based on at least one of a power-ON of the primary chiplet 102, a transition from the sleep or low power state, e.g., the L2 state 416, a failure to recover at least one of the set of mainband lanes 124, the one or more first sideband lanes 126, and the one or more second sideband lanes 128, a random resetting of the primary chiplet 102 to configure system updates in the primary chiplet 102, or the like. In the reset state 402, the interconnect 106 may be set to a predefined state as determined by the host processor of the primary chiplet 102. In the reset state 402, a troubleshooting of any faults in the primary chiplet 102 may occur.

After being in the reset state 402, the state machine 400 transitions to the first sideband initialization state 404a. In other words, the first sideband initialization state 404a may be triggered to initialize the one or more first sideband lanes 126. To initialize the one or more first sideband lanes 126, the control circuit 208a instructs the main module 108a to communicate the first data on the one or more first sideband lanes 126. For the sake of simplicity of explaining FIG. 4, it is assumed that the one or more first sideband lanes 126 may be faulty. Thus, a failure occurs in the communication of the first data via the one or more first sideband lanes 126, which may be detected by the control circuit 208a.

Upon detecting the failure of the communication of the first data via the one or more first sideband lanes 126, a timeout of the first sideband initialization state 404a may be disabled. Upon disabling the timeout of the first sideband initialization state 404a, the state machine 400 may be refrained from transitioning to the reset state 402 to reset the primary chiplet 102. The state machine 400 may be further unable to transition to the mainband initialization state 406 (denoted by “X” in FIG. 4). Instead, the state machine 400 transitions to the repurpose second sideband state 404b. In the repurpose second sideband state 404b, the control circuit 208a determines the capability of the auxiliary sideband port 206a to support the communication of the first data as indicated by the control register 210a and further identifies the capability of the peer auxiliary sideband port 206b to support the reception of the first data. The control circuit 208a may further reconfigure the auxiliary sideband port 206a based on the capability of the auxiliary sideband port 206a to support the communication of the first data and the capability of the peer auxiliary sideband port 206b to support the reception of the first data. The control circuit 208a may further set the one or more second bits 306 of the control register 210 to reconfigure the auxiliary sideband port 206a. In one aspect, if the one or more second sideband lanes 128 have been initialized (e.g., trained) based on the second data, the one or more second sideband lanes 128 may be further initialized based on the first data. In further aspects, if the one or more second sideband lanes 128 are yet to be initialized based on the second data and the failure of the communication via the one or more first sideband lanes 126 has occurred, the one or more second sideband lanes 128 may be initialized based on at least one of the first data and the second data. The control circuit 208 may thus control the communication of at least one of the first data and the second data upon reconfiguring the auxiliary sideband port 206a. In further aspects, prior to the failure of the communication via the one or more first sideband lanes 126, if the one or more second sideband lanes 128 have been initialized based on the second data, the control circuit 208a may determine that the initialization of the one or more second sideband lanes 128 may be unnecessary based on the similar configurations of the primary sideband port 204a and the auxiliary sideband port 206a (e.g. structural and functional similarity of the one or more first sideband lanes 126 and the one or more second sideband lanes 128, respectively). The state machine 400 may thus transition to the mainband initialization state 406.

In the mainband initialization state 406, the training data associated with the mainband data may be communicated to initialize the set of mainband lanes 124 as explained in FIG. 1. After the mainband initialization state 406, the state machine 400 transitions to the mainband training state 408. The set of mainband lanes 124 may be trained based on the lane training parameters (e.g., the training data) communicated during the mainband initialization state 406.

After the mainband training state 408, the state machine 400 transitions to a link initialization state 410. The link initialization state 410 refers to a readiness of the set of mainband lanes 124. In other words, the transition to the link initialization state 410 indicates that the set of mainband lanes 124 are now initialized and ready for communication of the operational data as the mainband data. In other words, the interconnect 106 is activated in the link initialization state 410 and the activation of the interconnect 106 may be indicative of the successful training of the set of mainband lanes 124 and the one or more second sideband lanes 128.

After the link initialization state 410, the state machine 400 transitions to the active state 412 for the communication of the operational data as the mainband data via the set of mainband lanes 124 and the first data (e.g., the control data) and the second data and (e.g., the management data) via the one or more second sideband lanes 128. The control circuit 208a may further control the communication of the first data and the second data by timesharing the reconfigured auxiliary sideband port 206a. The state machine 400 may remain in the active state 412 until an event may trigger the transition of the state machine 400 to another state.

In one scenario, the other state may be the PHY retraining state 414. In the PHY retraining state 414, a reconfiguration of the set of mainband lanes 124 may occur. The reconfiguration may occur based on modified lanes or parameters for the communication of the operational data. The reconfigured set of mainband lanes 124 may be further trained in the PHY retraining state 414. After the PHY retraining state 414, the state machine 400 may transition to the mainband training state 408 to train the reconfigured set of mainband lanes 124. The state machine 400 further transitions to the link initialization state 410 and the active state 412.

In further scenarios, the state machine 400 may transition to the L1/L2 state 416. The L1/L2 state 416 may be indicative of a low power or standby state. The state machine 400 may be in the L1/L2 state 416 when the interconnect 106 may be idle due to absence of data transfer on the interconnect 106 thereby saving power and improving thermal efficiency of the primary chiplet 102. The state machine 400 may further transition to the reset state 402 from the sleep state 416, e.g., the L2 state, and the state machine 400 may transition to the mainband training state 408 from the low-power state 416, e.g., the L1 state 416.

The state machine 400 may transition to the training error state 418 during any of the aforementioned states. The training error state 418 may be a last state indicative of a fault or defect in the primary chiplet 102. The faults may be associated with failed initialization of the interconnect 106, loss of communication between the primary chiplet 102 and the peer chiplet 104, structural defects in the primary chiplet 102, and the like.

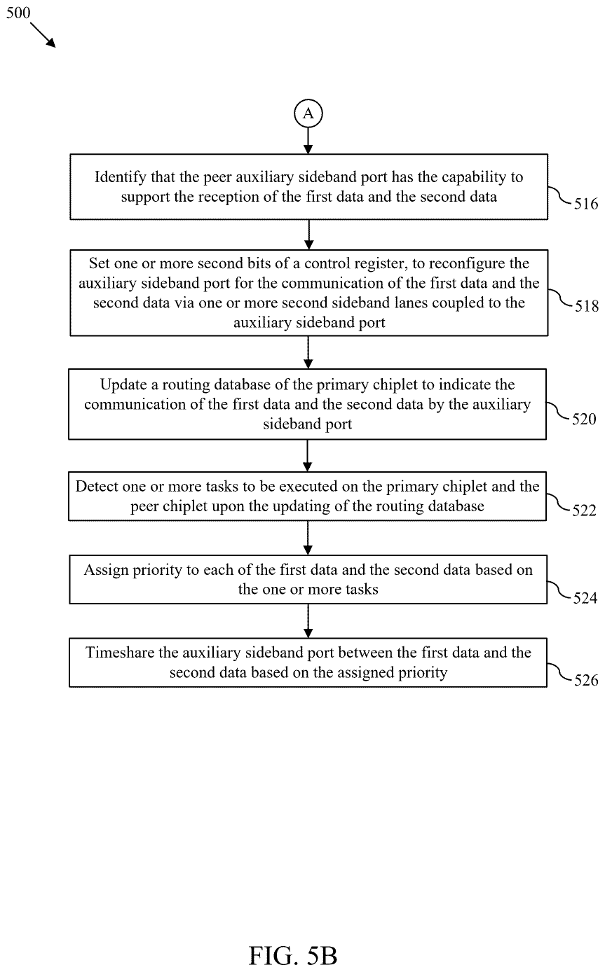

FIGS. 5A and 5B are a flowchart 500 that illustrate a method (e.g., a process) executed by a control circuit 208a of the primary chiplet 102 of FIG. 2 in accordance with certain aspects of the present disclosure. FIGS. 5A and 5B are described in conjunction with FIGS. 1, 2, 3A, and 3B.

At 502, the initialization of one or more first sideband lanes associated with a primary sideband port of a primary chiplet may be triggered. The initialization of the one or more first sideband lanes 126 associated with the primary sideband port 204a of the primary chiplet 102 may be triggered by the control circuit 208a. The control circuit 208a may trigger the initialization to synchronize the communication between the primary chiplet 102 and the peer chiplet 104. In one aspect, the control circuit 208a may select the main module 108a to establish the communication with the peer chiplet 104 based on the availability of the main module 108a. Thus, the training of the one or more first sideband lanes 126 may be triggered by the control circuit 208a via the main module 108a. The one or more first sideband lanes 126 may be associated with the primary sideband port 204a. Further, the routing database 214a may be configured to indicate the communication of the first data via the primary sideband port 204a.

At 504, based on the triggering of the initialization, a failure to communicate first data via one or more first sideband lanes associated with the primary sideband port to a peer chiplet may be detected. The control circuit 208a may be configured to detect, based on the triggering of the initialization, a failure to communicate the first data via the one or more first sideband lanes 126 associated with the primary sideband port 204a to the peer chiplet 104. The failure may occur due to the loss of communication of the first data on the one or more first sideband lanes 126, a fault in the one or more first sideband lanes 126, an operational fault or a structural defect in the primary sideband port 204a due to degradation over time, environmental conditions, aging, physical stress, or the like.

At 506, it is determined whether an auxiliary sideband port of the primary chiplet supports communication of the first data. Upon detecting the failure, the control circuit 208a may be configured to determine whether the auxiliary sideband port 206a supports the communication of the first data in addition to the second data. The one or more first bits of the control register 210a may indicate whether the auxiliary sideband port 206a supports the communication of the first data or not. For example, the one or more first bits may be set during power-ON of the primary chiplet 102 to indicate that the auxiliary sideband port 206a supports the communication of the first data.

At 506, if it is determined that the auxiliary sideband port of the primary chiplet is unable to support the communication of the first data, 508 may be executed. The control circuit 208a may determine that the auxiliary sideband port 206a of the primary chiplet 102 is unable to support the communication of the first data. For example, if the one or more first bits of the control register 210a are not set or if the control register 210a is absent in the primary chiplet 102, the control circuit 208a may determine that the auxiliary sideband port 206a is either absent in the primary chiplet 102 or the auxiliary sideband port 206a is unable to support the communication of the first data.

At 508, a reset of the one or more first sideband lanes may be initiated. The control circuit 208a may be configured to reset the one or more first sideband lanes 126.

At 510, the auxiliary sideband port may be instructed to advertise to a peer auxiliary sideband port of the peer chiplet, a capability of the auxiliary sideband port to communicate the first data in addition to the second data to the peer auxiliary sideband port. If at 506, it is determined the auxiliary sideband port 206a of the primary chiplet 102 supports the communication of the first data, 510 is executed. The control circuit 208a may determine the capability of the auxiliary sideband port 206a to communicate the first data in addition to the second data to the peer auxiliary sideband port 206b. The capability may further be determined based on the select register 212a. If the select register 212a indicates the capability of the auxiliary sideband port 206a to multiplex the first data in addition to the second data, the control circuit 208a may be further configured to instruct the auxiliary sideband port 206a to advertise the capability of the auxiliary sideband port 206a to communicate the first data in addition to the second data to the peer auxiliary sideband port 206b.

At 512, the auxiliary sideband port may be instructed to transmit a query to the peer auxiliary sideband port regarding a capability of the peer auxiliary sideband port to support reception of the first data in addition to the second data. The control circuit 208a may generate the query and provide the query to the auxiliary module 110a. The control circuit 208a may further instruct the auxiliary sideband port 206a by way of the auxiliary module 110a to transmit the query to the peer auxiliary sideband port 206b regarding the capability of the peer auxiliary sideband port 206b to support the reception of the first data in addition to the second data. In further aspects, 510 and 512 may occur upon power-ON of the electronic system 100 and prior to the detection of the failure.

At 514, it is determined whether the acknowledgement is received. The control circuit 208a may be configured to determine whether the acknowledgement is received based on the transmitted query. The control circuit 208a may wait for a time duration that may be defined or dynamic based on a distance between the primary chiplet 102 and the peer chiplet 104, a response time of the peer chiplet 104, or the like. At 514, if it is determined that the acknowledgement has not been received at an end of the time duration, the control circuit 208b may identify that the peer auxiliary sideband port 206b may be incapable to support the reception of the first data in addition to the second data. Thus, 508 may be executed.

At 516, a capability of the peer auxiliary sideband port to support the reception of the first data in addition to the second data may be identified. At 514, if it is determined that the acknowledgement is received in the time duration, the control circuit 208a may identify the capability of the peer auxiliary sideband port 206b to support the reception of the first data in addition to the second data at 516.

At 518, one or more second bits of a control register may be set to reconfigure the auxiliary sideband port to communicate the first data in addition to the second data via one or more second sideband lanes coupled to the auxiliary sideband port. The control circuit 208a may be further configured to set the one or more second bits of the control register 210a, to reconfigure the auxiliary sideband port 206a to communicate the first data in addition to the second data via the one or more second sideband lanes 128. The one or more second bits may be set upon the reception of the acknowledgement.

At 520, a routing database of the primary chiplet to indicate the communication of the first data and the second data via the auxiliary sideband port may be updated. The control circuit 208a may further update the routing database 214a upon the reconfiguration of the auxiliary sideband port 206a. The updated routing database 214a may indicate the communication of the first data and the second data via the auxiliary sideband port 206a. The routing database 214a may be updated upon the setting of the one or more second bits of the control register 210a. In further aspects, 520 may occur prior to 518 or simultaneously with 518.

At 522, a task to be executed on the primary chiplet and the peer chiplet upon the updating of the routing database may be detected. The control circuit 208a may detect the task (e.g., the one or more tasks) to be executed on each of the primary chiplet 102 and the peer chiplet 104. The host processor of the primary chiplet 102 may determine the task to be executed on the primary chiplet 102. The task may be associated with one of the control of the mainband data or configuration of the management parameters in the peer chiplet 104.

At 524, a priority to each of the first data and the second data based on the detected task may be assigned. The assignment of the priority to each of the first data and the second data may be based on the detected task. Thus, one of the first data or the second data may be assigned with a higher priority level or a lower priority level.

At 526, the auxiliary sideband port may be timeshared between the first data and the second data based on the assigned priority. The control circuit 208a may control the routing of the first data from the main module 108a to the auxiliary module 110a via the NoC interface. The timesharing between the first data and the second data may be based on the task to be executed on each of the primary chiplet 102 and the peer chiplet 104. The communication via the auxiliary sideband port 206a may be split into time slots, with each of the main module 108a and the auxiliary module 110a being assigned with specific slots for providing the first data and the second data, respectively, to the auxiliary sideband port 206a. The data having the higher priority level may be assigned with an earlier time slot and communicated via the auxiliary sideband port 206a whereas the data having the lower priority level is assigned with a later time slot and communicated via the auxiliary sideband port 206a after the communication of the data having the higher priority level. The control circuit 208a may thus control the communication of the first data and the second data via the one or more second sideband lanes 128 to the peer chiplet 104 based on the reconfigured auxiliary sideband port 206a.

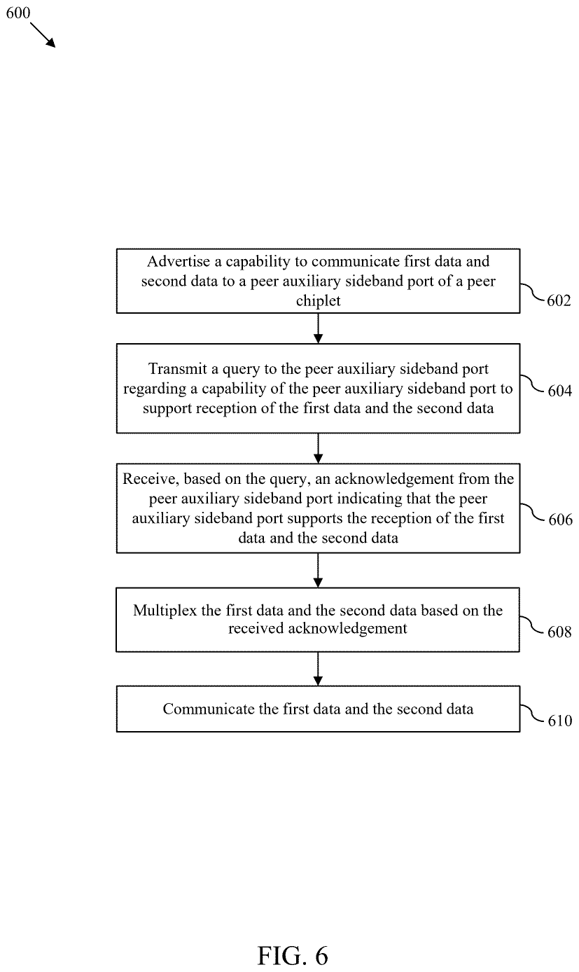

FIG. 6 is a flowchart 600 that illustrates a method (e.g., a process) executed by the auxiliary sideband port 206a of the primary chiplet 102 of FIG. 2 in accordance with certain aspects of the present disclosure. FIG. 6 is described in conjunction with FIGS. 1, 2, 3A, and 3B.

At 602, a capability to communicate first data in addition to the second data to the peer auxiliary sideband port may be advertised. In one aspect, the auxiliary sideband port 206a may communicate the second data prior to the advertisement. In further aspects, the auxiliary sideband port 206a may communicate the second data after the advertisement. The control circuit 208a may determine the capability of the auxiliary sideband port 206a to communicate the first data in addition to the second data to the peer auxiliary sideband port 206b based on the failure to communicate the first data on the one or more first sideband lanes 126. The capability may further be determined based on the one or more second bits of the control register 210a. The control circuit 208a may thus instruct the auxiliary sideband port 206a to advertise the capability of the auxiliary sideband port 206a to communicate the first data in addition to the second data to the peer auxiliary sideband port 206b.

At 604, a query to the peer auxiliary sideband port regarding a capability of the peer auxiliary sideband port to support reception of the first data in addition to the second data may be transmitted. The control circuit 208a may generate the query for the peer auxiliary sideband port 206b to identify the capability of the peer auxiliary sideband port 206b to support the reception of the first data in addition to the second data. The control circuit 208a may thus instruct the auxiliary sideband port 206a by way of the auxiliary module 110a, to transmit the query to the peer auxiliary sideband port 206b regarding the capability of the peer auxiliary sideband port 206b to support the reception of the first data in addition to the second data.

At 606, an acknowledgement from the peer auxiliary sideband port indicating that the peer auxiliary sideband port supports the reception of the first data in addition to the second data may be received, based on the query. Upon transmitting the query to the peer auxiliary sideband port 206b, the control circuit 208a waits to receive the acknowledgement from the peer chiplet 104 by way of the peer auxiliary sideband port 206b regarding the capability of the peer auxiliary sideband port 206b to support the reception of the first data in addition to the second data. If the peer auxiliary sideband port 206b is configured to support the reception of the first data in addition to the second data, the auxiliary sideband port 206a may receive the acknowledgement within the time duration.

At 608, the first data and the second data based on the received acknowledgement may be multiplexed. Based on the received acknowledgement, the control circuit 208a may identify that the peer auxiliary sideband port 206b has the capability to support the reception of the first data in addition to the second data. The control circuit 208a may further refer to the select register 212a. The select register 212a may be indicative of the capability of the auxiliary sideband port 206a to multiplex the first data and the second data. The control circuit 208a may thus reconfigure the auxiliary sideband port 206a to communicate the second data in addition to the first data.

At 610, the first data in addition to the second data may be communicated. The auxiliary sideband port 206a may be timeshared between the first data and the second data. The timesharing between the first data and the second data may be based on the task to be executed on each of the primary chiplet 102 and the peer chiplet 104. Based on the task to be executed, one of the first data or the second data may be assigned with a higher priority level or a lower priority level. The data having the higher priority level may be communicated via the auxiliary sideband port 206a whereas the data having the lower priority level may be communicated via the auxiliary sideband port 206a after the communication of the data having the higher priority level. The auxiliary sideband port 206a may thus be reconfigured to communicate the first data and the second data.

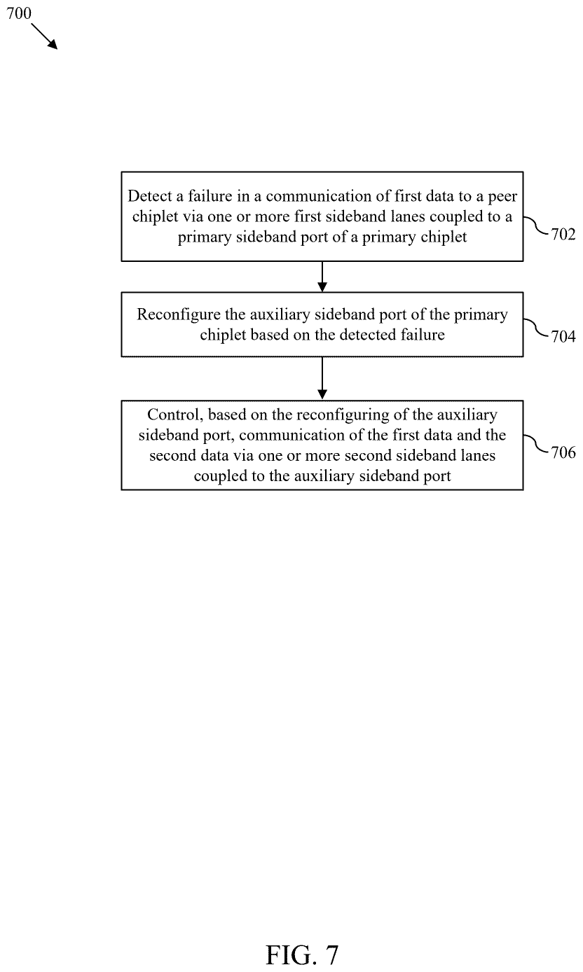

FIG. 7 is a high-level flowchart 700 that illustrates a method (e.g., a process) executed by the control circuit 208a of the primary chiplet 102 of FIG. 2 in accordance with certain aspects of the present disclosure. FIG. 7 is described in conjunction with FIGS. 1, 2, 3A, and 3B.

At 702, a failure in a communication of first data to a peer chiplet via one or more first sideband lanes coupled to a primary sideband port of the primary chiplet may be detected. The control circuit 208a may detect the failure in the communication of the first data to the peer chiplet 104 via the one or more first sideband lanes 126 coupled to the primary sideband port 204a of the primary chiplet 102. The failure may be detected based on the faulty one or more first sideband lanes 126.

At 704, an auxiliary sideband port of the primary chiplet may be reconfigured based on the detected failure, to communicate the first data in addition to second data, to the peer chiplet via one or more second sideband lanes coupled to the auxiliary sideband port. The control circuit 208a may reconfigure the auxiliary sideband port 206a of the primary chiplet 102 based on the detected failure. In an example, the control circuit 208a may set the one or more first bits 304 of the control register 302 to reconfigure the auxiliary sideband port 206a of the primary chiplet 102.

At 706, a communication of the first data and the second data via the one or more second sideband lanes to the peer chiplet may be controlled, based on the reconfiguring of the auxiliary sideband port. Upon reconfiguring the auxiliary sideband port 206a, the control circuit 208a may control the communication of the first data in addition to second data, to the peer chiplet 104 via the one or more second sideband lanes 128 coupled to the auxiliary sideband port 206a. For example, the control circuit 208a may timeshare the auxiliary sideband port 206a between the first data and the second data based on the assigned priority thereby controlling the communication of the first data and the second data to the peer chiplet 104.

Though the processes illustrated by the flowchart 500, the flowchart 600, and the high-level flowchart 700 of FIGS. 5-7, respectively, are mentioned to be executed by at least one of the control circuit 208a and the auxiliary sideband port 206a of the primary chiplet 102, in various aspects, the processes may be executed by at least one of the control circuit 208b and the peer auxiliary sideband port 206b of the peer chiplet 104.

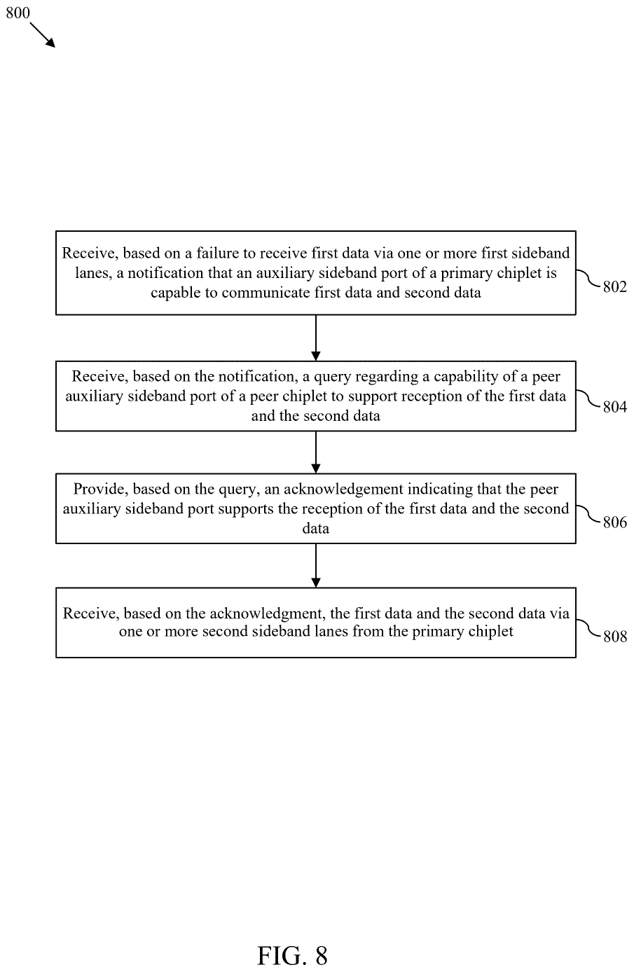

FIG. 8 is a flowchart 800 that illustrates a method (e.g., a process) executed by the peer auxiliary sideband port 206b of the peer chiplet 104 of FIG. 2 in accordance with certain aspects of the present disclosure. FIG. 8 is described in conjunction with FIGS. 1, 2, 3A, and 3B.

At 802, a notification that an auxiliary sideband port of a primary chiplet is capable to communicate first data in addition to second data may be received, based on a failure to receive first data via one or more first sideband lanes. The notification may be received during the advertisement from the auxiliary sideband port 206a based on a failure to receive the first data via the one or more first sideband lanes 126. The notification may indicate that the auxiliary sideband port 206a of the primary chiplet 102 may be capable to communicate first data in addition to second data. Based on the received notification during the advertisement, the control circuit 208b may identify that the auxiliary sideband port 206a may be capable to communicate the first data in addition to the second data. The control circuit 208b may further confirm a reception of the notification to the primary chiplet 102 via the peer auxiliary sideband port 206b and the one or more second sideband lanes 128.

At 804, a query regarding a capability of a peer auxiliary sideband port to support reception of first data in addition to the second data may be received, based on the notification. In one aspect, the peer auxiliary sideband port 206b may receive the second data prior to the reception of the query. In further aspects, the peer auxiliary sideband port 206b may receive the query prior to the reception of the second data. The control circuit 208a may determine the capability of the auxiliary sideband port 206a to communicate the first data in addition to the second data to the peer auxiliary sideband port 206b. The control circuit 208a may thus instruct the auxiliary sideband port 206a to transmit the query to the peer auxiliary sideband port 206b to identify the capability of the peer auxiliary sideband port 206b to support the reception of the first data in addition to the second data.

At 806, an acknowledgement indicating that the peer auxiliary sideband port supports the reception of the first data in addition to the second data may be provided. The control circuit 208b may generate the acknowledgement based on the peer auxiliary sideband port 206b having the capability to receive the first data in addition to the second data. The peer auxiliary sideband port 206b may be configured to provide the acknowledgement. The control circuit 208b may identify that the peer auxiliary sideband port 206b has the capability to receive the first data in addition to the second data based on the one or more first bits of the control register 210b and the select register 212b. Further, the one or more first bits of the control register 210b may be set to enable the reception of the first data and the second data via the peer auxiliary sideband port 206b. The control circuit 208a may thus update the routing database 214a to indicate the communication of the first data and the second data via the auxiliary sideband port 206a. Thus, the auxiliary sideband port 206a may be reconfigured to communicate the first data in addition to the second data to the peer auxiliary sideband port 206b.

At 808, the first data in addition to the second data via the one or more second sideband lanes from the primary chiplet, may be received. The peer auxiliary sideband port 206b may be reconfigured to receive the first data in addition to the second data via the one or more second sideband lanes 128 from the primary chiplet 102 (e.g., the auxiliary sideband port 206a), based on the acknowledgement. The peer auxiliary sideband port 206b may be timeshared to receive the first data and the second data.

Though the process illustrated by the flowchart 800 is mentioned to be executed by the peer auxiliary sideband port 206b of the peer chiplet 104, in various aspects the process may be executed by the auxiliary sideband port 206a of the primary chiplet 102.

FIG. 9 is a block diagram of a chiplet 900 in accordance with certain aspects of the present disclosure. The chiplet 900 may be one of the primary chiplet 102 and the peer chiplet 104. FIG. 9 is described in conjunction with FIGS. 1, 2, 3A, and 3B. Examples of the chiplet 900 may be a processor, a memory, an input/output controller, or any other suitable circuitry to execute a desired operation of the electronic system 100. The chiplet 900 may include a host processor 902, a memory 904, a UCIe controller such as the control circuit 906, a communication interface 908, a module 910, a module 912, and an input/output interface 914.

The host processor 902 may be configured to execute critical operations of the primary chiplet 102. Further, the host processor 902 may be configured to control each component of the primary chiplet 102. In an example, the host processor 902 may be a CPU of the chiplet 900. The host processor 902 may instruct the control circuit 906 to initiate the communication between the primary chiplet 102 and the peer chiplet 104.

The memory 904 may be configured to store instructions that facilitate various operations of the host processor 902. Examples of the memory 904 may include a random-access memory (RAM), a read only memory (ROM), a programmable ROM (PROM), an erasable PROM (EPROM), an electrically erasable PROM (EEPROM), and any other suitable medium for storing commands, software, and/or instructions that may be accessed and read by the host processor 902. In an aspect, the memory 904 may be a non-transitory computer-readable medium. The memory 904 may further include the control register 210a, the select register 212a, and the routing database 214a. The instructions stored in the memory 904 may be associated with training parameters, management parameters, identifiers of the primary chiplet 102 and the peer chiplet 104, port and module addresses of the primary chiplet 102, commands to generate at least one of the mainband data, sideband data, or the like.

The control circuit 906 may refer to the control circuit 208a and the control circuit 208b and may be configured to execute at least the operations of the control circuit 208a and the control circuit 208b as explained with reference to FIGS. 1, 2, and 4. The control circuit 906 may further be configured to reconfigure the sideband port 934 based on the failure of the communication of the first data via the sideband port 926, and control, based on the reconfigured sideband port 934, communication of the first data and the second data. Examples of the control circuit 906 may include but are not limited to, an application-specific integrated circuit (ASIC) processor, a reduced instruction set computer (RISC) processor, a complex instruction set computer (CISC) processor, a field programmable gate array (FPGA), a microprocessor, a microcontroller, and the like.

The control circuit 906 may execute operations by means of a processor core executing software stored in the memory 904, or the control circuit 906 may execute software stored on the memory 904 using its own processing resources. Software shall be construed broadly to mean instructions, instruction sets, code, code segments, program code, programs, subprograms, software dies, applications, software applications, software packages, routines, subroutines, objects, executables, threads of execution, procedures, functions, etc., whether referred to as software, firmware, middleware, microcode, hardware description language, or otherwise. In various aspects, the host processor 902 may execute the operations of the control circuit 906.

The communication interface 908 may include any number of interconnecting buses and bridges that may enable communication between the control circuit 906, the module 910, the module 912, and the remaining components of the chiplet 900. The communication interface 908 may also link various other circuits such as clock circuitry, input/output peripherals, buffers, various modules, power management circuitry, and other processing cores, of the chiplet 900. The communication interface 908 may further include circuitry of the NoC interface that may include routers, links, arbitration circuitry that may include multiplexers, switches, and the like. In an example, the communication interface 908 enables the routing of the first data from the module 910 to the module 912.

The input/output interface 914 may be configured to provide a communication interface between the primary chiplet 102 and components external to the chiplet 900 to exchange various data and resources.

The module 910 may be at least one of the main module 108a or the main module 108b. The module 910 may include a processing circuit 916, a module memory 918, PHY circuitry 920, a mainband port 924, and a sideband port 926. The processing circuit 916 may be configured to process the instructions received from the control circuit 906 and control the operations of the module 910. The processing circuit 916 may be configured to execute the operations of the adapter layer and the protocol layer of a UCIe chiplet. In some examples, the processing circuit 916 may be configured to convert data associated with a chiplet protocol into a compatible format for communication on the interconnect 106.

The processing circuit 916 may be configured to generate the first data based on the setup commands. The processing circuit 916 may further be configured to execute the training of the set of mainband lanes 124 and the one or more first sideband lanes 126, identify the failure of the one or more first sideband lanes 126, and report the failures in the communication of at least one of the first data and the mainband data to the control circuit 208a (e.g., report errors in translation, transmission, or reception of at least one of the first data and the mainband data to the control circuit 906). The processing circuit 916 may further be configured to negotiate with other modules of the primary chiplet 102 via the control circuit 906 to communicate the first data based on the failed communication of the first data via the one or more first sideband lanes 126, route the first data to the module 912 based on the failure of the one or more first sideband lanes 126, and the like. Examples of the processing circuit 916 may include microprocessors, microcontrollers, digital signal processors (DSPs), field programmable gate arrays (FPGAs), programmable logic devices (PLDs), state machines, gated logic, discrete hardware circuits, and any combination of hardware, software, and/or firmware to execute the operations of the module 910. The module 910 may further include other components (not shown) configured to perform various functions of the module 910 that are associated with the primary chiplet 102.

The module memory 918 may be configured to store instructions and/or code associated with at least one of the training of the interconnect 106, the setup commands, control parameters associated with the generation of the first data, failure logs associated with the failure of the communication of at least the first data, identifiers of each component of the module 910, the mapping between data associated with each of the mainband port 924 and the sideband port 926, and the like. Examples of the module memory 918 may include a RAM, a ROM, a floppy disk drive, a magnetic tape drive, a compact disc, an optical disk drive, a flash memory, a non-transitory computer-readable medium, and the like.

The PHY circuitry 920 may be configured to manage high speed communication of the mainband and sideband data via the interconnect 106. In addition, the PHY circuitry 920 may be configured to execute the training of the set of mainband lanes 124 and the one or more first sideband lanes 126, manage the communication of the mainband and sideband data on the mainband port 924 and the sideband port 926, and the like.

The mainband port 924 may be configured to manage high speed data communication. A high-speed data communication may refer to a data rate of 2 Gigabit (Gbit)/second, 64 Gbit/second, 126 Gbit/second, or the like. In an example, the mainband data may adhere to a high-speed data communication protocol such as PCIe, CXL, or any other high speed communication protocol as will be apparent to a person skilled in the art. The mainband port 924 may be further coupled to the set of mainband lanes 124 to communicate the mainband data. The mainband data communicated on the mainband port 924 may have low latency. The mainband port 924 may further include a transmitter and a receiver as described in FIG. 1. The mainband port 924 may correspond to the mainband port 202a and the mainband port 202b.

The sideband port 926 may be configured to manage low speed data communication. A low-speed data communication may refer to a data rate of 3.4 Megabit (Mbit)/second, 50 Mbit/second, or the like. In an example, the sideband data may adhere to a low-speed data communication protocol such as Inter-Integrated communication (I2C), Serial Peripheral Interface (SPI), vendor specific protocols, or the like. The sideband port 926 may be further coupled to the one or more first sideband lanes 126 and may be configured to communicate the first data. The sideband port 926 may further include a transmitter and a receiver as described in FIG. 1. The sideband port 926 may correspond to the primary sideband port 204a and the peer sideband port 204b.

The module 912 may be at least one of the auxiliary module 110a or the auxiliary module 110b. The module 912 may include a processing circuit 928, a module memory 930, PHY circuitry 932, and a sideband port 934.

The processing circuit 928 may be configured to process the instructions received from the control circuit 906 and control the operations of the module 912. The processing circuit 928 may be configured to execute the operations of the adapter layer and the protocol layer of a UCIe chiplet. The processing circuit 928 may be configured to convert second data associated with a chiplet protocol into a compatible format for communication with a receiving chiplet. The processing circuit 928 may be configured to generate the second data based on the management commands received from the control circuit 906. The processing circuit 928 may further be configured to instruct the PHY circuitry 932 to execute the training of the one or more second sideband lanes 128, report real-time status of the communication of at least one of the first data and the second data to the control circuit 906 via the one or more second sideband lanes 128, execute a handshake between the module 910 and the module 912 to receive the first data based on the failed communication of the first data via the one or more first sideband lanes 126, and the like. Examples of the processing circuit 928 may include microprocessors, microcontrollers, digital signal processors (DSPs), field programmable gate arrays (FPGAs), programmable logic devices (PLDs), state machines, gated logic, discrete hardware circuits, and any combination of hardware, software, and/or firmware to execute the operations of the module 912. The module 912 may further include other components (not shown) configured to perform various functions of the module 912 that are associated with the primary chiplet 102.

The module memory 930 may be configured to store instructions and/or code associated with at least one of the initialization of the one or more second sideband lanes 128, the management commands, control parameters associated with the generation of the second data, identifiers of each component of the module 912, the mapping between data associated with the sideband port 934, and the like. Examples of the module memory 930 may include a RAM, a ROM, a floppy disk drive, a magnetic tape drive, a compact disc, an optical disk drive, a flash memory, a non-transitory computer-readable medium, and the like.

The PHY circuitry 932 may be configured to manage low-bandwidth communication of the management data. The PHY circuitry 932 may be configured to manage the communication of the management data on the sideband port 934. In addition, the PHY circuitry 932 may be configured to manage the communication of the first data in addition to the second data (e.g., the management data) on the sideband port 934, and the like.

The sideband port 934 may be structurally and functionally similar to the sideband port 926. Thus, the sideband port 934 may be configured to manage low speed communication of the management data. Further, the management data may adhere to a low-speed data communication protocol such as I2C, SPI, vendor specific protocols, or the like. The sideband port 934 may be further coupled to the one or more second sideband lanes 128. Further, the sideband port 934 may be reconfigured to communicate the first data in addition to the second data via the one or more second sideband lanes 128 in an event of failure of the communication of the first data via the one or more first sideband lanes 126. The sideband port 934 may include a transmitter and a receiver as described in FIG. 1. Further, the sideband port 934 may correspond to the auxiliary sideband port 206a.

The circuit architecture described herein may be implemented on one or more ICs, chips, chiplets, modules, interposers, packages, system printed circuit boards (PCBs), and the like. The circuit architecture described herein may also be fabricated with various process technologies such as complementary metal oxide semiconductor (CMOS), NMOS, PMOS, bipolar junction transistor (BJT), bipolar-CMOS (BiCMOS), silicon germanium (SiGe), gallium arsenide (GaAs), heterojunction bipolar transistors (HBTs), high electron mobility transistors (HEMTs), silicon-on-insulator (SOI), etc.

Thus, the primary chiplet 102 can communicate the first data to the peer chiplet 104 via the one or more second sideband lanes 128 in the event of a failure of the one or more first sideband lanes 126. The communication of the first data via the one or more second sideband lanes 128 occurs based on the capability of the auxiliary sideband port 206a to support first data in addition to the second data. Further, the design of the primary chiplet 102 enables the routing of the first data from the main module 108a to the auxiliary module 110a. Thus, a yield of the electronic system 100 is improved as compared to prior art techniques that rendered a chiplet unusable in an event of a sideband lane failure. Further, a reliability of the electronic system 100 is enhanced over conventional systems that include chiplets which may be rendered unusable in an event of the failure. In addition, as the communication of the second data via the one or more second sideband lanes 128 is intermittent, an idle time of the one or more second sideband lanes 128 for the communication of the first data may be reduced over conventional chiplets that communicate only management data over a sideband port of an auxiliary module.

The present disclosure provides a simple solution to detect the capability of the auxiliary sideband port 206a by way of the control register 210a and the select register 212a. In various aspects, the present solution may be implemented for advanced packages having a sideband module. When redundant ports of an advanced package fail in addition to a failure of a communication of sideband data via a sideband port of the advanced package, an auxiliary sideband port of the sideband module may be utilized to communicate the data of the failed sideband port. The present disclosure further offers improved efficiency of the primary chiplet 102 over chiplets that have redundant ports and do not have the capability to communicate the management data via the redundant ports.

The control circuit 208a of the present disclosure may be capable to detect in real-time, whether the first data or the second data can be communicated at a given time, on the one or more second sideband lanes 128. Further, the conventional communication of the mainband data via the set of mainband lanes 124 remains unperturbed in an event of a failure of the primary sideband port 204a. In addition, the auxiliary sideband port 206a remains reconfigured for the communication of the first data in future communications with the peer chiplet 104.

Techniques consistent with the present disclosure provide, among other features, systems, and methods for managing sideband failures between chiplets.

It is understood that the specific order or hierarchy of steps in the processes disclosed is an illustration of exemplary approaches. Based on design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The aforementioned description is provided to enable any person skilled in the art to practice the various aspects described herein. Various modifications to these aspects will be readily apparent to those skilled in the art, and the generic principles defined herein may be applied to further aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. No claim element is to be construed as a means plus function unless the element is expressly recited using the phrase “means for.” Further, unless stated otherwise, terms such as “first” and “second” are used to arbitrarily distinguish between the elements such terms describe. Thus, these terms are not necessarily intended to indicate temporal or other prioritization of such elements. The term “coupled” may refer to at least one of direct or indirect coupling that may not necessarily be by way of mechanical or any physical means. Further, a system or method that “comprises”, “has”, or “includes” one or more elements possesses those one or more elements but is not limited to possessing only those one or more elements.

What is claimed is:

1. A primary chiplet, comprising:
a primary sideband port configured to communicate first data to a peer chiplet via one or more first sideband lanes;
an auxiliary sideband port configured to communicate second data to the peer chiplet via one or more second sideband lanes; and
a control circuit configured to:
detect a failure in the communication of the first data via the one or more first sideband lanes;
reconfigure the auxiliary sideband port based on the detected failure; and
control, based on the reconfigured auxiliary sideband port, communication of the first data and the second data via the one or more second sideband lanes to the peer chiplet.

2. The primary chiplet of claim 1, wherein the control circuit is further configured to assign a priority to each of the first data and the second data based on the detection of the failure.

3. The primary chiplet of claim 2, wherein the assignment of the priority to each of the first data and the second data is further based on one or more tasks executed on the primary chiplet and the peer chiplet.

4. The primary chiplet of claim 2, wherein the control of the communication of the first data and the second data via the one or more second sideband lanes is further based on the assigned priority to each of the first data and the second data.

5. The primary chiplet of claim 1, wherein the control circuit is further configured to trigger initialization of the one or more first sideband lanes, and wherein the detection of the failure is based on the triggering of the initialization of the one or more first sideband lanes.

6. The primary chiplet of claim 1, wherein the first data comprises one or more control parameters associated with a communication of mainband data between the primary chiplet and the peer chiplet, and the second data comprises one or more management parameters associated with management functions of the primary chiplet and the peer chiplet.

7. The primary chiplet of claim 1, wherein the control circuit is further configured to determine, upon the detection of the failure, whether the auxiliary sideband port supports the communication of the first data, and wherein the auxiliary sideband port is reconfigured further based on the determination that the auxiliary sideband port supports the communication of the first data.

8. The primary chiplet of claim 7, further comprising a control register that comprises one or more first bits to indicate that the auxiliary sideband port supports the communication of the first data, wherein the determination of whether the auxiliary sideband port supports the communication of the first data is based on the one or more first bits.

9. The primary chiplet of claim 8, wherein the control register further comprises one or more second bits, and wherein the control circuit is further configured to set the one or more second bits, upon the detection of the failure, to reconfigure the auxiliary sideband port for the communication of the first data and the second data via the one or more second sideband lanes.

10. The primary chiplet of claim 1, wherein the auxiliary sideband port is further configured to multiplex the first data and the second data based on the reconfigured auxiliary sideband port.

11. The primary chiplet of claim 10, further comprising a select register that is indicative of a capability of the auxiliary sideband port to multiplex the first data and the second data.

12. The primary chiplet of claim 1, wherein the control circuit is further configured to timeshare the auxiliary sideband port between the first data and the second data based on the reconfigured auxiliary sideband port.

13. The primary chiplet of claim 1, wherein the auxiliary sideband port is communicatively coupled to a peer auxiliary sideband port of the peer chiplet, and wherein, upon the detection of the failure, the auxiliary sideband port is further configured to advertise a capability of the auxiliary sideband port to communicate the first data and the second data via the one or more second sideband lanes to the peer auxiliary sideband port.

14. The primary chiplet of claim 13, wherein the auxiliary sideband port is further configured to transmit a query to the peer auxiliary sideband port regarding a capability of the peer auxiliary sideband port to support reception of the first data and the second data.

15. The primary chiplet of claim 14, wherein
the auxiliary sideband port is further configured to receive, based on the transmitted query, an acknowledgement from the peer auxiliary sideband port that indicates the capability of the peer auxiliary sideband port to support the reception of the first data and the second data, and
the auxiliary sideband port is reconfigured further based on the acknowledgement.

16. The primary chiplet of claim 1, further comprising a routing database configured to indicate the communication of the first data by the primary sideband port and the communication of the second data by the auxiliary sideband port, prior to the detection of the failure.

17. The primary chiplet of claim 16, wherein
upon the detection of the failure, the control circuit is further configured to update the routing database to indicate the communication of the first data and the second data by the auxiliary sideband port, and
the control of the communication of the first data and the second data via the one or more second sideband lanes is further based on the updated routing database.

18. The primary chiplet of claim 1, further comprising:
a main module that comprises a mainband port and the primary sideband port, wherein the main module is configured to support mainband communication and sideband communication; and
an auxiliary module that comprises the auxiliary sideband port, wherein the auxiliary module is configured to support the sideband communication.

19. A peer chiplet, comprising:
a peer sideband port configured to receive first data from a primary chiplet via one or more first sideband lanes; and
a peer auxiliary sideband port configured to:
receive second data from the primary chiplet via one or more second sideband lanes; and
receive, based on a failure in the reception of the first data via the one or more first sideband lanes, the first data and the second data via the one or more second sideband lanes from the primary chiplet.

20. A method executed at a primary chiplet, the method comprising:
detecting a failure in a communication of first data to a peer chiplet via one or more first sideband lanes coupled to a primary sideband port of the primary chiplet;
reconfiguring an auxiliary sideband port of the primary chiplet based on the detected failure; and
controlling, based on the reconfiguring of the auxiliary sideband port, communication of the first data and second data, to the peer chiplet via one or more second sideband lanes coupled to the auxiliary sideband port.
